(19) United States
(12) Patent Application Publication
(10) Pub. No.: US 2025/0039897 A1
(43) Pub. Date: Jan. 30, 2025

(54) MECHANISM FOR REPETITION OF PHYSICAL DOWNLINK CONTROL CHANNEL

(71) Applicant: Nokia Technologies Oy, Espoo (FI)

(72) Inventors: Bo BI, Hangzhou (CN); Arman AHMADZADEH, München (DE); Alessio MARCONE, Munich (DE); Frank FREDERIKSEN, Klarup (DE)

(21) Appl. No.: 18/780,741

(22) Filed: Jul. 23, 2024

Related U.S. Application Data
(63) Continuation of application No. PCT/CN2023/109202, filed on Jul. 25, 2023.

(51) Int. Cl. H04W 72/231; H04W 28/26; H04W 72/0446

(52) U.S. Cl. CPC H04W 72/231; H04W 28/26; H04W 72/0446

(57) ABSTRACT

The present disclosure relates to a solution for PDCCH repetition. In particular, a terminal device determines transmission resources for a set of repetitions of a physical downlink control channel (PDCCH). The terminal device monitors the set of repetitions of the PDCCH from a network device based on the transmission resources. In this way, it can reduce latency for the terminal device and can also decrease a buffer size at the terminal device.

### FIELDS

Various example embodiments of the present disclosure generally relate to the field of telecommunication and in particular, to methods, devices, apparatuses and computer readable storage medium for repetition of physical downlink control channel (PDCCH).

### BACKGROUND

Coverage enhancement is a hot topic in communication field. For example, it may focus on an applicability of solutions developed by general new radio (NR) coverage enhancement to non-terrestrial network (NTN), and identifying potential issues and enhancements, considering the NTN characteristics including large propagation delay and satellite movement.

### SUMMARY

In a first aspect of the present disclosure, there is provided an apparatus. The apparatus comprises at least one processor; and at least one memory storing instructions that, when executed by the at least one processor, cause the apparatus to: determine transmission resources for a set of repetitions of a physical downlink control channel (PDCCH); and monitor the set of repetitions of the PDCCH from a network device based on the determined transmission resources.

In a second aspect of the present disclosure, there is provided an apparatus. The apparatus comprises at least one processor; and at least one memory storing instructions that, when executed by the at least one processor, cause the apparatus to: transmit, to a terminal device, a set of repetitions of a physical downlink control channel (PDCCH) based on transmission resources.

In a third aspect of the present disclosure, there is provided a method. The method comprises: determining transmission resources for a set of repetitions of a physical downlink control channel (PDCCH); and monitoring the set of repetitions of the PDCCH from a network device based on the determined transmission resources.

In a fourth aspect of the present disclosure, there is provided a method. The method comprises: transmitting, to a terminal device, a set of repetitions of a physical downlink control channel (PDCCH) based on transmission resources.

In a fifth aspect of the present disclosure, there is provided a first apparatus. The first apparatus comprises means for determining transmission resources for a set of repetitions of a physical downlink control channel (PDCCH); and means for monitoring the set of repetitions of the PDCCH from a network device based on the determined transmission resources.

In a sixth aspect of the present disclosure, there is provided a second apparatus. The second apparatus comprises means for transmitting, to a terminal device, a set of repetitions of a physical downlink control channel (PDCCH) based on transmission resources.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling chart for communication according to some example embodiments of the present disclosure;

FIG. 3A to FIG. 3C illustrate schematic diagrams of multiplexing patterns, respectively;

FIG. 4A to FIG. 4C illustrate schematic diagrams of common search space (CSS) sets, respectively;

FIG. 5A and FIG. 5B illustrate schematic diagrams of transmission resources for PDCCH repetitions according to some example embodiments of the present disclosure;

FIG. 6A and FIG. 61 illustrate schematic diagrams of transmission resources for PDCCH repetitions according to some example embodiments of the present disclosure;

FIG. 7A and FIG. 7F illustrate schematic diagrams of transmission resources for PDCCH repetitions according to some example embodiments of the present disclosure;

FIG. 8 illustrates a schematic diagram of repetition pattern according to some example embodiments of the present disclosure;

FIG. 9A to FIG. 9C illustrate signaling charts for communication according to some example embodiments of the present disclosure, respectively;

FIG. 10A to FIG. 10C illustrate schematic diagrams of repetition patterns according to some example embodiments of the present disclosure, respectively;

FIG. 11 illustrates a flowchart of a method implemented at a first device according to some example embodiments of the present disclosure;

FIG. 12 illustrates a flowchart of a method implemented at a second device according to some example embodiments of the present disclosure;

FIG. 13 illustrates a simplified block diagram of a device that is suitable for implementing example embodiments of the present disclosure; and

FIG. 14 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), an Access Terminal (AT) or a very small aperture terminal (VSAT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “common search space (CSS)” may refer to a search space (i.e., a set of resources) that every UE needs to search for control signals for every UE or signaling message that is applied to every UE before dedicated channel is established for a specific UE. The term “control resource set (CORESET)” used herein may refer to a physical resource that is used to carry physical downlink control channel (PDCCH). The term “a repetition factor” used herein may refer the number of repetitions. The term “bitmap” used herein may refer to a string including binary number. The term “monitoring occasion (MO)” used herein may refer to a set of resources that is used for control channel monitoring.

As mentioned above, coverage enhancement is one of the important aspects of communication system design. In NTN, when considering satellite power limitations (due to for example regulatory requirements or power split among the beams of the satellite), the UL and DL channels related to initial access need to be enhanced. In some solutions, when considering Power Flux Density (PFD) limits or more generically limits on satellite output power, coverage enhancements for the PDCCH channel are necessary.

In general, for improving coverage, there are three fundamental approaches that can be considered. These are: (a) lowering the interference and noise contributions (not relevant for this use case), (b) increasing the transmission power (not possible for this use case due to the satellite PFD limits), and (c) increasing the received energy per bit (through either reducing the payload or by transmitting over longer time). The latter is typically achieved by introducing repetitions of the channel to be enhanced. In the current 5G NR specifications, the repetition of Type0A/1/2/3 common search space (CSS) and UE specific search space (USS) PDCCH has been specified for the multi-transmission reception point (TRP) feature and its mechanism could be extended for NTN, at least for the PDCCH channels in radio resource control (RRC) connected mode.

For improving the physical layer performance of a channel, the approach that is typically used is to assign a larger number of resources for transmission of the data or control channel for a certain number of bits (in case of data and/or control channel). One approach to achieve this is to repeat the transmission of the payload data multiple times to give the possibility to a receiver to combine the received signals and improve the reliability of the demodulated and decoded bits. Based on this, one of the methods that could be followed in the enhancements of the coverage of the Type0-PDCCH, would be to repeat the Type0-PDCCH multiple times in a same or different slot, and thereby allow a UE receiver to combine the received Type0-PDCCH single transmissions. However, in order to be able to combine the multiple Type0-PDCCH repetitions, it is necessary for the UE to know at least if and how many repetitions are being transmitted by the gNB, and hence the time span of the Type0-PDCCH repetitions.

According to some example embodiments of the present disclosure, there is provided a solution for PDCCH repetition. In particular, a network device transmits system information that includes a parameter related to a PDCCH common search space set with repetition to a terminal device. The terminal device determines a configuration of the PDCCH common search space set with repetition based on the parameters. The terminal device 110 further monitors a set of repetitions of a PDCCH based on the configuration. In this way, it can improve the coverage enhancement.

According to some example embodiments of the present disclosure, there is provided a solution for PDCCH repetition. In particular, a terminal device determines transmission resources for a set of repetitions of a physical downlink control channel (PDCCH). The set of repetitions may be a set of intra-slot repetitions. Alternatively, or in addition, the set of repetitions may be repetitions across two consecutive slots. The terminal device monitors the set of repetitions of the PDCCH from a network device based on the transmission resources. In this way, it can reduce latency for the terminal device and can also decrease a buffer size at the terminal device.

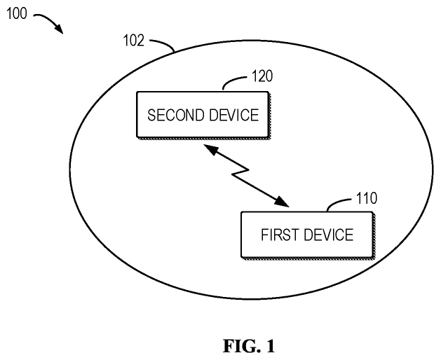

FIG. 1 illustrates an example communication environment 100 in which example embodiments of the present disclosure can be implemented. In the communication environment 100, a plurality of communication devices, including a first device 110 and a second device 120, can communicate with each other.

In the following, for the purpose of illustration, some example embodiments are described with the first device 110 operating as a terminal device and the second device 120 operating as a network device. However, in some example embodiments, operations described in connection with a terminal device may be implemented at a network device or other device, and operations described in connection with a network device may be implemented at a terminal device or other device.

The first device 110 may be capable of receiving downlink control information (DCI) carried by Type0-PDCCH CCS set with repetitions, i.e., Rel-19 NTN UEs capable of Type0-PDCCH repetition, which may also be referred to as type 1 UE. The communication environment 100 may also include other terminal devices that are not capable of receiving DCI carried by Type0-PDCCH CCS set with repetitions, including legacy UEs and Rel-19 NTN UEs not capable of Type0-PDCCH reception with repetition, which can be referred to as type 2 UE.

In some example embodiments, if the first device 110 is a terminal device and the second device 120 is a network device, a link from the second device 120 to the first device 110 is referred to as a downlink (DL), and a link from the first device 110 to the second device 120 is referred to as an uplink (UL). In DL, the second device 120 is a transmitting (TX) device (or a transmitter) and the first device 110 is a receiving (RX) device (or a receiver). In UL, the first device 110 is a TX device (or a transmitter) and the second device 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Example embodiments of the present disclosure will be described in detail below with reference to the accompanying drawings.

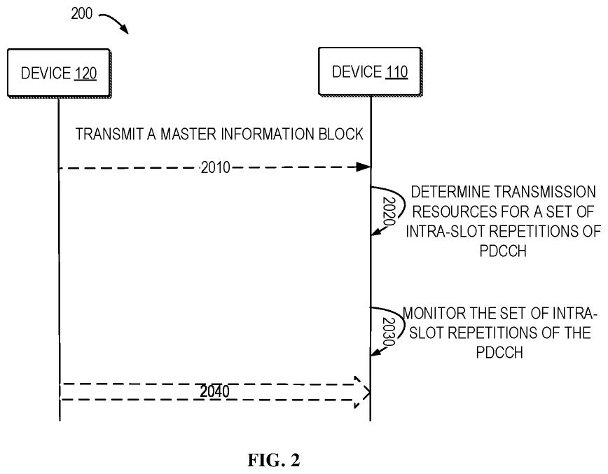

Reference is now made to FIG. 2, which shows a signaling chart 200 for communication according to some example embodiments of the present disclosure. As shown in FIG. 2, the signaling chart 200 involves a first device 110, and a second device 120. For the purpose of discussion, reference is made to FIG. 1 to describe the signaling chart 200.

The second device 120 may transmit (2010) a master information block (MIB) to the first device 110. In other words, the first device 110 may receive the MIB from the second device 120.

The first device 110 may obtain a control resource set (CORESET) and search space (i.e., refers to the area in the downlink resource grid where PDCCH may be carried. UE perform blind decoding throughout these search space trying to find PDCCH data) for Type0-PDCCH based on a MIB parameter. For example, during cell search, the first device 110 may determine from MIB that a CORESET for Type0-PDCCH common search space (CSS) set is present, and the first device 110 may determine a number of consecutive resource blocks and a number of consecutive symbols for the CORESET of the Type0-PDCCH CSS set from controlResourceSetZero in pdcch-ConfigSIB1, as described in Tables 13-1 through 13-10 in technical specification (TS) 38.213, for operation without shared spectrum channel access in frequency range (FR)1 and FR2-1, or as described in Tables 13-1A and 13-4A in TS 38.213 for operation with shared spectrum channel access in FR1, or as described in Table 13-10A in TS 38.213 for operation with shared spectrum channel access in FR2-2, and determine PDCCH monitoring occasions from searchSpaceZero in pdcch-ConfigSIB1, included in MIB, as described in Tables 13-11 through 13-15A operation with shared spectrum channel access in.

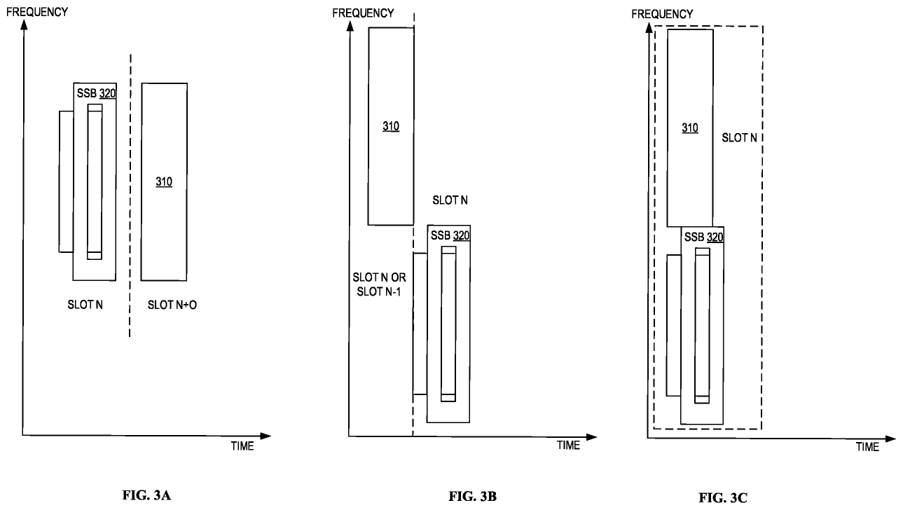

There may be 3 kinds of schemes for the SS PBCH block (SSB) and CORESET0 multiplexing that is so-called multiplexing pattern, as shown in FIG. 3A to FIG. 3C. FIG. 3A shows a schematic diagram of SS PBCH block and CORESET0 multiplexing pattern 1. As shown in FIG. 3A, the SS PBCH block 320 may be transmitted in slot n and the CORESET0 310 may be in slot n+O or subsequent slots, where O is an integer number. The SS PBCH block 320 and the CORESET 310 may overlap in frequency domain. FIG. 3B shows a schematic diagram of SS PBCH block and CORESET0 multiplexing pattern 2. As shown in FIG. 3B, the SS PBCH block 320 may be transmitted in slot n and the CORESET0 310 may be in previous slot of n and n is an integer number. FIG. 3C shows a schematic diagram of SS PBCH block and CORESET0 multiplexing pattern 3. As shown in FIG. 3c, the SS PBCH block 320 may be transmitted in slot n and the CORESET0 310 may be in slot n. The SS PBCH block 320 and the CORESET 310 may overlap in time domain. In some embodiments, for SSB/CORESET0 multiplexing pattern 3, they may be in the same slot, and for multiplexing pattern 2, they may be either on the same slot or on two consecutive slots according to Table 13-13 through 13-15A in TS 38.213.

In some embodiments, for SS PBCH block and CORESET0 multiplexing pattern 1, the number of search space sets may be set to 1 or 2, which is associated to 1 or 2 SSB indexes, respectively. When the number of search space sets per slot is 2, there may be two options regarding the location that each CSS set (associated with an SSB index) occupies within the slot. One option may be that 2 CSS sets occupy consecutive symbols. The second possibility may be that one CSS set may occupy a set of consecutive symbols in a first half of the slot, the other CSS set may occupy another set of consecutive symbols in a second half of the slot.

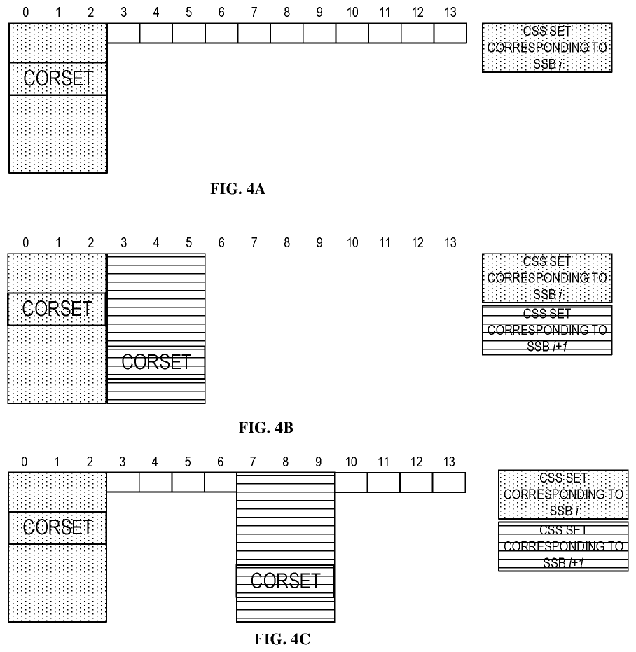

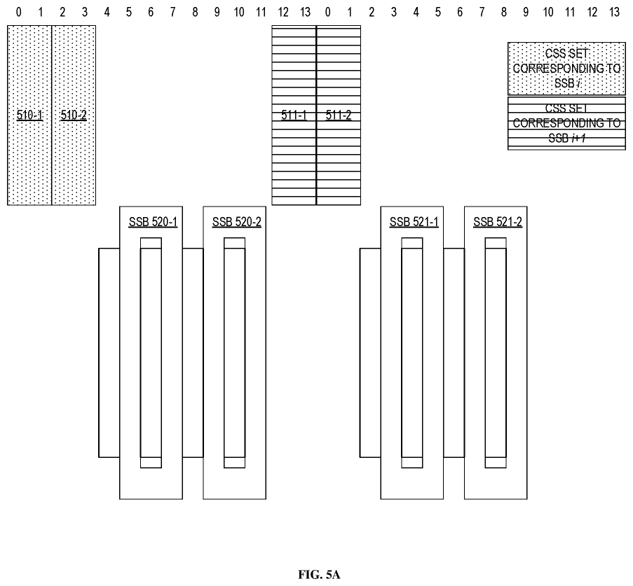

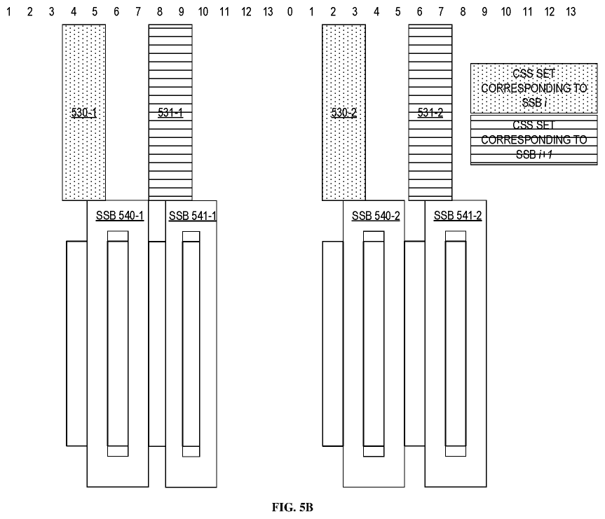

FIG. 4A illustrates a case where there may be a CSS set per slot. In this case, the number of symbols of CORESET0 is 3, i.e., N_{symb}^{CORESET}=3. FIG. 4B illustrates a case where there may be 2 CSS sets per slot and N_{symb}^{CORESET}=3. As shown in FIG. 4B, the first symbol of the CSS set associated with SSB with even index (SSB i in FIG. 4B) starts from the first symbol of the slot, i.e., OFDM symbol index 0, and the first symbol of the CSS set associated with SSB with odd index (SSB i+1 in FIG. 4B) starts right after the last symbol of the former CSS set. In other words, two CSS set (i.e., two CORESETs) are allocated back-to-back OFDM symbols. In some other embodiments, as shown in FIG. 3C, the first symbol of the CSS set associated with SSB with even index (SSB i in FIG. 4C) may start from the first symbol of the slot, i.e., OFDM symbol index 0, and the first symbol of the CSS set associated with SSB with odd index (SSB i+1 in FIG. 4B) may start from OFDM symbol index 7, (i.e., the first symbol of the second half of the slot).

The first device 110 may assume that half frames with SS/PBCH blocks occur with a periodicity of 2 frames. In other words, the minimal periodicity of SSB may be 2 frames (20 ms), i.e., 2Nₛₗₒₜ^{frame,μ}, wherein Nₛₗₒₜ^{frame,μ} is specified by Table 4.3.2-1 in 38.211, show is shown below.

TABLE 4.3.2-1
Number of OFDM symbols per slot, slots per frame,
and slots per subframe for normal cyclic prefix.

| μ | N_{symb}^{slot} | Nₛₗₒₜ^{frame,μ} | Nₛₗₒₜ^{subframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |
| 6 | 14 | 640 | 64 |

For a half frame with SS/PBCH blocks, the first symbol indexes for candidate SS/PBCH blocks are determined according to the SCS of SS/PBCH blocks as follows, where index 0 corresponds to the first symbol of the first slot in a half-frame.
For initial cell selection, a UE may assume that half frames with SS/PBCH blocks occur with a periodicity of 2 frames.

In some embodiments, according to Table 13-13, 13-14 in TS 38.123 shown as below, for SSB/CORESET0 multiplexing pattern 2, the first device 110 may determine the first symbol index by

$$\{ \begin{matrix}0 , i = 4 k \\ 1 , i = 4 k + 1 \\ 6 , i = 4 k + 2 \\ 7 , i = 4 k + 3\end{matrix} ,$$

$$k = 0 , 1 , … , 15$$

$$or$$

$$\{ \begin{matrix}0 , i = 8 k , 8 k + 6 , {n}_{c} = {n}_{SSB , i} \\ 1 , i = 8 k + 1 , 8 k + 7 , {n}_{c} = {n}_{SSB , i} \\ 2 , i = 8 k + 2 , {n}_{c} = {n}_{SSB , i} \\ 3 , i = 8 k + 3 , {n}_{c} = {n}_{SSB , i} \\ 12 , i = 8 k + 4 , {n}_{c} = {n}_{SSB , i} - 1 \\ 13 , i = 8 k + 5 , {n}_{c} = {n}_{SSB , i} - 1\end{matrix}$$

k=0, 1, . . . , 7, where i is the SSB index.

TABLE 13-13
PDCCH monitoring occasions for Type0-PDCCH CSS set-
SS/PBCH block and CORESET multiplexing pattern 2 and
{SS/PBCH block, PDCCH} SCS {120, 60} kHz

| | PDCCH monitoring occasions | First symbol index |
|---|---|---|
| Index | (SFN and slot number) | (k = 0, 1, . . . 15) |
| 0 | SFN_{c} = SFN_{SSB,i} | 0, 1, 6, 7 for |
| | n_{c} = n_{SSB,i} | i = 4k, i = 4k + 1, i = 4k + 2, |
| | | i = 4k + 3 |

| | |
|---|---|
| 1 | Reserved |
| 2 | Reserved |
| 3 | Reserved |
| 4 | Reserved |
| 5 | Reserved |
| 6 | Reserved |
| 7 | Reserved |
| 8 | Reserved |
| 9 | Reserved |
| 10 | Reserved |
| 11 | Reserved |
| 12 | Reserved |
| 13 | Reserved |
| 14 | Reserved |
| 15 | Reserved |

TABLE 13-14
PDCCH monitoring occasions for Type0-PDCCH CSS set-
SS/PBCH block and CORESET multiplexing pattern 2 and
{SS/PBCH block, PDCCH} SCS {240, 120} kHz

| | PDCCH monitoring | |
|---|---|---|
| | occasions | First symbol index |
| Index | (SFN and slot number) | (k = 0, 1, . . . , 7) |
| 0 | SFN_{c} = SFN_{SSB,i} | 0, 1, 2, 3, 0, 1 in |
| | n_{c} = n_{SSB,i} or | i = 8k, i = 8k + 1, |
| | n_{c} = n_{SSB,i} − 1 | i = 8k + 2, i = 8k + 3, |
| | | i = 8k + 6, i = 8k + 7 |
| | | (n_{c} = n_{SSB,i}) |
| | | 12, 13 in i = 8k + 4, |
| | | i = 8k + 5 |
| | | (n_{c} = n_{SSB,i} − 1) |

| | |
|---|---|
| 1 | Reserved |
| 2 | Reserved |
| 3 | Reserved |
| 4 | Reserved |
| 5 | Reserved |
| 6 | Reserved |
| 7 | Reserved |
| 8 | Reserved |
| 9 | Reserved |
| 10 | Reserved |
| 11 | Reserved |
| 12 | Reserved |
| 13 | Reserved |
| 14 | Reserved |
| 15 | Reserved |

FIG. 5A shows a schematic diagram of SSB and CORESET multiplexing pattern 2. As shown in FIG. 5A, subcarrier spacing (SCS) of SSB may be 120 kHz and SCS of PDCCH may be 60 kHz. The CORESET 510-1 and the CORESET 510-2 may correspond to the SSB 520-1 and the SSB 520-2, respectively. The CORESET 511-1 and the CORESET 511-2 may correspond to the SSB 521-1 and the SSB 521-2, respectively. According to the following 2 tables (i.e., Table 13-7 and Table 13-10 in TS 38.123) where the frequency domain resource for COERSET0 in multiplexing pattern 2 is configured, there may be couples of reserved indices that can be repurposed for repetition specific configuration.

TABLE 13-7
Set of resource blocks and slot symbols of CORESET
for Type0-PDCCH search space set when
{SS/PBCH block, PDCCH} SCS is {120, 60} kHz

| | SS/PBCH block and | Number of | Number of | |
|---|---|---|---|---|
| | CORESET multiplexing | RBs | Symbols | Offset |
| Index | pattern | N_{RB}^{CORESET} | N_{symb}^{CORESET} | (RBs) |
| 0 | 1 | 48 | 1 | 0 |
| 1 | 1 | 48 | 1 | 8 |
| 2 | 1 | 48 | 2 | 0 |
| 3 | 1 | 48 | 2 | 8 |
| 4 | 1 | 48 | 3 | 0 |
| 5 | 1 | 48 | 3 | 8 |
| 6 | 1 | 96 | 1 | 28 |
| 7 | 1 | 96 | 2 | 28 |
| 8 | 2 | 48 | 1 | −41 if |
| | | | | k_{SSB} = 0 |
| | | | | −42 if |
| | | | | k_{SSB} > 0 |
| 9 | 2 | 48 | 1 | 49 |
| 10 | 2 | 96 | 1 | −41 if |
| | | | | k_{SSB} = 0 |
| | | | | −42 if |
| | | | | k_{SSB} > 0 |
| 11 | 2 | 96 | 1 | 97 |

| | |
|---|---|
| 12 | Reserved |
| 13 | Reserved |
| 14 | Reserved |
| 15 | Reserved |

TABLE 13-10
Set of resource blocks and slot symbols of CORESET
for Type0-PDCCH search space set when
{SS/PBCH block, PDCCH} SCS is {240, 120} kHz

| | SS/PBCH block and | Number of | Number of | |
|---|---|---|---|---|
| | CORESET multiplexing | RBs | Symbols | Offset |
| Index | pattern | N_{RB}^{CORESET} | N_{symb}^{CORESET} | (RBs) |
| 0 | 1 | 48 | 1 | 0 |
| 1 | 1 | 48 | 1 | 8 |
| 2 | 1 | 48 | 2 | 0 |
| 3 | 1 | 48 | 2 | 8 |
| 4 | 2 | 24 | 1 | −41 if |
| | | | | k_{SSB} = 0 |
| | | | | −42 if |
| | | | | k_{SSB} > 0 |
| 5 | 2 | 24 | 1 | 25 |
| 6 | 2 | 48 | 1 | −41 if |
| | | | | k_{SSB} = 0 |
| | | | | −42 if |
| | | | | k_{SSB} > 0 |
| 7 | 2 | 48 | 1 | 49 |

| | |
|---|---|
| 8 | Reserved |
| 9 | Reserved |
| 10 | Reserved |
| 11 | Reserved |
| 12 | Reserved |
| 13 | Reserved |
| 14 | Reserved |
| 15 | Reserved |

In some embodiments, according to Table 13-15, 13-15A in TS 38.123 shown as below, for SSB/CORESET0 multiplexing pattern 3, the first device 110 may determine the first symbol index by:

$$\{ \begin{matrix}4 , i = 4 k \\ 8 , i = 4 k + 1 \\ 2 , i = 4 k + 2 \\ 6 , i = 4 k + 3\end{matrix} ,$$

$$k = 0 , 1 , … , 15$$

$$or$$

$$\{ \begin{matrix}2 , i = 2 k \\ 9 , i = 2 k + 1\end{matrix} ,$$

$$k = 0 , 1 , … , 31.$$

TABLE 13-15
PDCCH monitoring occasions for Type0-PDCCH CSS set-SS/PBCH block
and CORESET multiplexing pattern 3 and {SS/PBCH block, PDCCH} SCS
{120, 120} kHz

| | PDCCH monitoring occasions | First symbol index |
|---|---|---|
| Index | (SFN and slot number) | (k = 0, 1, . . . 15) |
| 0 | SFN_{c} = SFN_{SSB,i} | 4, 8, 2, 6 in |
| | n_{c} = n_{SSB,i} | i = 4k, i = 4k + 1, i = 4k + 2, |
| | | i = 4k + 3 |

| | |
|---|---|
| 1 | Reserved |
| 2 | Reserved |
| 3 | Reserved |
| 4 | Reserved |
| 5 | Reserved |
| 6 | Reserved |
| 7 | Reserved |
| 8 | Reserved |
| 9 | Reserved |
| 10 | Reserved |
| 11 | Reserved |
| 12 | Reserved |
| 13 | Reserved |
| 14 | Reserved |
| 15 | Reserved |

TABLE 13-15A
PDCCH monitoring occasions for Type0-PDCCH CSS set-SS/PBCH block
and CORESET multiplexing pattern 3 and {SS/PBCH block, PDCCH} SCS
{480, 480} kHz or {960, 960} kHz

| | PDCCH monitoring occasions | First symbol index |
|---|---|---|
| Index | (SFN and slot number) | (k = 0, 1, . . . 31) |
| 0 | SFN_{c} = SFN_{SSB,i} | 2, 9 in |
| | n_{c} = n_{SSB,i} | i = 2k, i = 2k + 1 |

| | |
|---|---|
| 1 | Reserved |
| 2 | Reserved |
| 3 | Reserved |
| 4 | Reserved |
| 5 | Reserved |
| 6 | Reserved |
| 7 | Reserved |
| 8 | Reserved |
| 9 | Reserved |
| 10 | Reserved |
| 11 | Reserved |
| 12 | Reserved |
| 13 | Reserved |
| 14 | Reserved |
| 15 | Reserved |

FIG. 5B shows a schematic diagram of SSB and CORESET multiplexing pattern 3. As shown in FIG. 5B, SCS of SSB may be 120 kHz and SCS of PDCCH may be 120 kHz. The CORESET 530-1 and the CORESET 530-2 may correspond to the SSB 540-1 and the SSB 540-2, respectively. The CORESET 531-1 and the CORESET 531-2 may correspond to the SSB 541-1 and the SSB 541-2, respectively.

The first device 110 determines (2020) transmission resources for a set of repetitions of the PDCCH. In some embodiments, the set of repetitions is a set of intra-slot repetition. Alternatively, or in addition, the set of repetitions is a set of repetitions within two consecutive slots. The first device 110 may also determine an initial set of transmission resources for an initial transmission of the PDCCH. The first device 110 monitors (2030) the set of repetitions of the PDCCH from the second device 120 based on the determined transmission resources. In other words, the second device 120 transmits the set of repetitions of the PDCCH to the first device 110.

In some example embodiments, the Type0-PDCCH CSS set in a monitoring occasion slot may be extended for the determination of the transmission resources of the repetitions of the PDCCH. For example, the Type0-PDCCH CSS can be extended for transmission of the repetitions of the PDCCH that is the repetition CSS is linking to the original CSS that is used for the initial transmission of the PDCCH. In this case, the first device 110 that is Type1 UE can monitor the repetitions CSS to improve Type0-PDCCH receiving performance. Other devices that are Type2 UE monitor the original Type0-PDCCH CSS and ignore the linked CSS. By way of example, the original CSS corresponding CSS set may be denoted as S₀^{ss_set,k}, CSS for repetitions may be denoted as {S₀^{ss_set,k},S₁^{ss_set,k}, . . . ,S_{K-1}^{ss_set,k}}, where K may denote the number of repetitions, k e {0, 1, . . . , N_{ss_set}^{slot}−1}, Bⱼ^{ss_set,k} and Oⱼ^{ss_set,k} may denote starting symbol index and offset of CSS Sⱼ^{ss_set,k} respectively. In the following descriptions, Kᵢₙₜᵣₐ₋ₛₗₒₜ may replace the parameter K to represent the number of repetitions (i.e., the repetitions factor). In this case, the Type2 UE may monitor symbols of [B₀^{ss_set,k}, B₀^{ss_set,k}+Oⱼ^{ss_set,k}] that is the fallback mechanism for backward compatibility and the first device 110 may monitor symbols of [Bⱼ^{ss_set,k},Bⱼ^{ss_set,k}+Oⱼ^{ss_set,k}] for receptions of Type0-PDCCH.

In some example embodiments, the Type0-PDCCH CSS set in a monitoring occasion slot may be extended for the determination of the transmission resources of the repetitions of the PDCCH. For example, the Type0-PDCCH CSS can be extended for transmission of the repetitions of the PDCCH by extending the First symbol index field to multiple values for SSB index. For example, for the first row of Table 13-15 in TS 38.213, the field First symbol index may be modified as shown in Table 1, where each value of First symbol index is constituted by two values, indicating the first symbol index in the slot for the PDCCH initial transmission and PDCCH repetition.

TABLE 1
Example of modified Table 13-15 for conveying PDCCH repetitions

| | PDCCH monitoring occasions | First symbol index |
|---|---|---|
| Index | (SFN and slot number) | (k = 0, 1, . . . 15) |
| 0 | SFN_{c} = SFN_{SSB,i} | {0, 4}, {2, 8}, {10, 2}, |
| | n_{c} = n_{SSB,i} | {12, 6} in i = 4k, i = 4k + 1, |
| | | i = 4k + 2, i = 4k + 3 |

In some example embodiments, the Type0-PDCCH CSS set in a monitoring occasion slot may be extended for the determination of the transmission resources of the repetitions of the PDCCH. For example, the Type0-PDCCH CSS can be extended for transmission of the repetitions of the PDCCH by extending the First symbol index field to multiple values for SSB index. For example, for the first row of Table 13-11 in TS 38.213 (which is shown later) for M=1, the field First symbol index may be modified as shown in Table 2, wherein the value of First symbol index is constituted by two values, indicating the first symbol index in the slot for the PDCCH initial transmission and PDCCH repetition.

TABLE 2
Example of modified Table 13-11 for conveying PDCCH repetitions

| | | Number of search | | First symbol |
|---|---|---|---|---|
| Index | 0 | space sets per slot | M | index |
| 0 | 0 | 1 | 1 | {0, N_{symb}^{CORESET}} |

In some example embodiments, the Type0-PDCCH CSS set in a monitoring occasion slot may be extended for the determination of the transmission resources of the repetitions of the PDCCH. For example, the Type0-PDCCH CSS can be extended for transmission of the repetitions of the PDCCH by extending the First symbol index field to multiple values for SSB index. For example, for the second row of Table 13-11 in TS 38.213 for M=½, the field First symbol index may be modified as shown in Table 3, wherein the value of First symbol index per SSB index i is constituted by two values, indicating the first symbol index in the slot for the PDCCH initial transmission and PDCCH repetition.

TABLE 3
Example of modified Table 13-11 for conveying PDCCH repetitions

| | | Number of search | | First symbol |
|---|---|---|---|---|
| Index | 0 | space sets per slot | M | index |
| 0 | 0 | 1 | 1/2 | {0, 2 * N_{symb}^{CORESET}, |
| | | | | if i is even}, |
| | | | | {N_{symb}^{CORESET}, 3 * |
| | | | | N_{symb}^{CORESET}, if i is |
| | | | | odd} |

Alternatively, the frequency resource of CORESET0 may be extended for the determination of the transmission resources of the repetitions. In other words, other dedicated CORESET0 may be used for the repetitions of the PDCCH.

In some example embodiments, the first device 110 may determine a repetition factor for the PDCCH based on the determined transmission resources. For example, the first device 110 may determine the number of transmissions for the PDCCH, including an initial transmission and repetitions of the PDCCH. By way of example, for the SSB/CORESET0 multiplexing pattern 1, an intra-slot repetition factor may be determined based on the configured number of symbols of CORESET0 (N_{symb}^{CORESET}) and number of CSS sets (N_{ss_set}^{slot}) in the slot.

In an example embodiment, the first device 110 may determine the transmission resources for the set of repetitions of the PDCCH based on the number of symbols per slot, the number of symbols related to a control resource set of the PDCCH (for example, CORESET 0), and the number of search space sets per slot. For example, the number of repetition (Kᵢₙₜᵣₐ₋ₛₗₒₜ) (i.e., the repetition factor) can be determined by

$$⌊ \frac{{N}_{symb}^{slot}}{{N}_{symb}^{CORESET} {N}_{ss \_ set ,}^{slot}} ⌋ ,$$

where N_{symb}^{slot} denotes the number of symbols per slot (for example, 14), N_{symb}^{CORESET} denotes the number of symbols for each CORESET0 in Table 13-1 through 13-10 in TS 38.213, and N_{ss_set}^{slot} denotes the number of search space set in Table 13-11 through 13-12a in TS 38.213. For example, index 1 in Table 13-11 in TS 38.213 (multiplexing pattern 1) may be configured,

$${N}_{s y m b}^{CORESET} = 2 , {N}_{ss \_ set}^{slot} = 2 , {K}_{intra - slot} = ⌊ \frac{14}{2 * 2} ⌋ = 3 ,$$

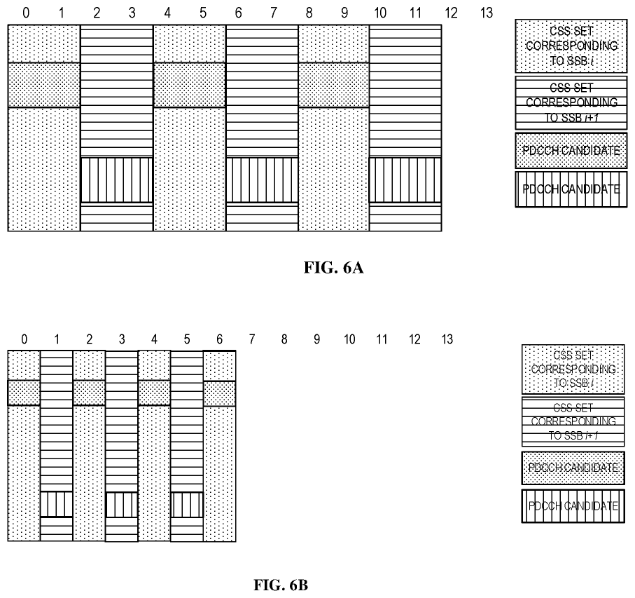

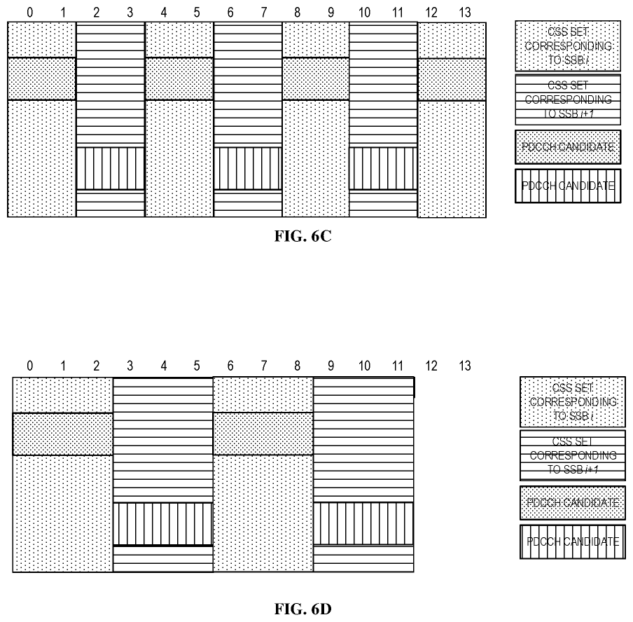

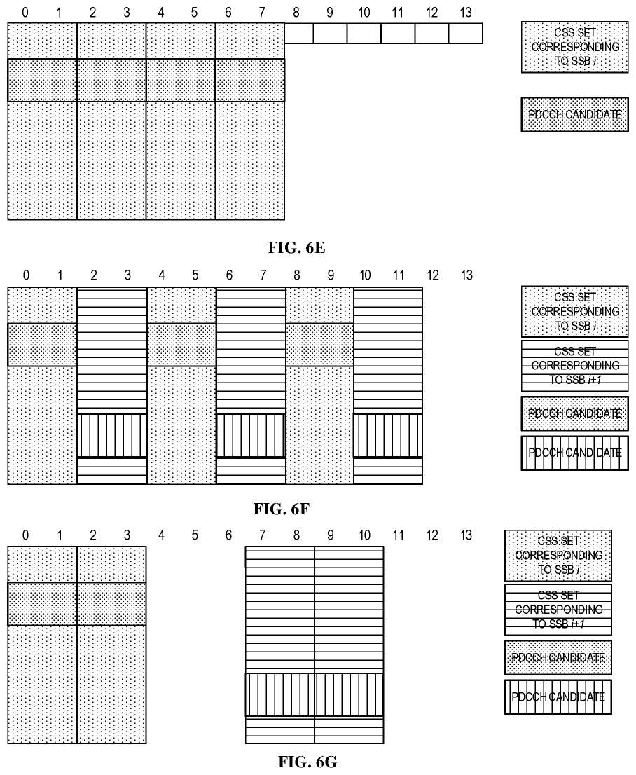

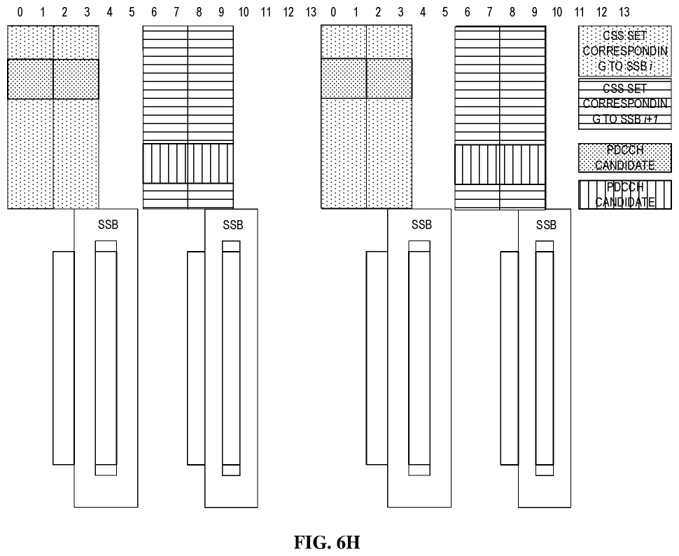

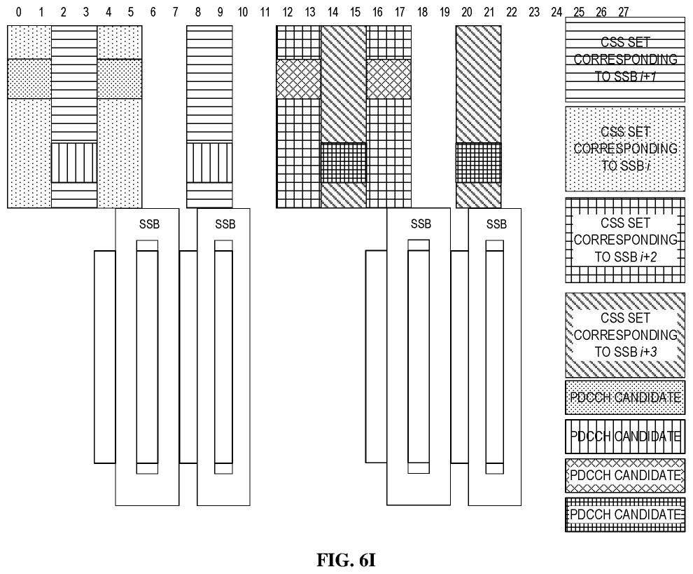

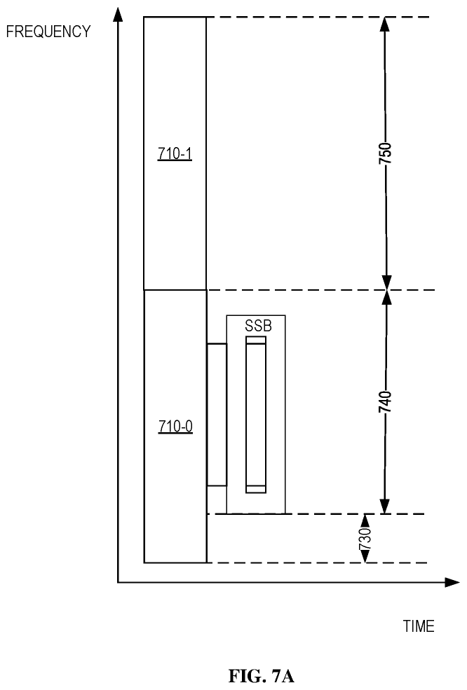

the repetition occasions may be shown in FIG. 6A. In this case, the first device 110 may monitor the set of repetitions on the repetition occasions shown in FIG. 6A. The second device 120 may transmit the set of repetitions on the repetition occasions shown in FIG. 6A. The term “PDCCH candidate” used here may refer to allocated PDCCH resources for transmission of downlink control information (DCI).

TABLE 13-11
Parameters for PDCCH monitoring occasions for Type0-PDCCH CSS
set-SS/PBCH block and CORESET multiplexing pattern 1 and FR1

| | | Number of search | | |
|---|---|---|---|---|
| Index | 0 | space sets per slot | M | First symbol index |
| 0 | 0 | 1 | 1 | 0 |
| 1 | 0 | 2 | 1/2 | {0, if i is even}, |
| | | | | {N_{symb}^{CORESET}, |
| | | | | if i is odd} |
| 2 | 2 | 1 | 1 | 0 |
| 3 | 2 | 2 | 1/2 | {0, if i is even}, |
| | | | | {N_{symb}^{CORESET}, if i is odd} |
| 4 | 5 | 1 | 1 | 0 |
| 5 | 5 | 2 | 1/2 | {0, if i is even}, |
| | | | | {N_{symb}^{CORESET}, if i is odd} |
| 6 | 7 | 1 | 1 | 0 |
| 7 | 7 | 2 | 1/2 | {0, if i is even}, |
| | | | | {N_{symb}^{CORESET}, if i is odd} |
| 8 | 0 | 1 | 2 | 0 |
| 9 | 5 | 1 | 2 | 0 |
| 10 | 0 | 1 | 1 | 1 |
| 11 | 0 | 1 | 1 | 2 |
| 12 | 2 | 1 | 1 | 1 |
| 13 | 2 | 1 | 1 | 2 |
| 14 | 5 | 1 | 1 | 1 |
| 15 | 5 | 1 | 1 | 2 |

In another example embodiment, the first device 110 may determine the transmission resources for the set of repetitions of the PDCCH based on the number of symbols per slot, the number of symbols related to a control resource set of the PDCCH, the number of search space sets per slot, and a number of symbols to be reserved for transmission of a scheduled physical downlink shared channel (PDSCH). For example, the repetition factor (Kᵢₙₜᵣₐ₋ₛₗₒₜ) can be determined by

$$⌊ \frac{{N}_{symb}^{slot} - {R}_{symb}^{PDSCH \_ sib 1}}{{N}_{s y m b}^{C O R E S E T} {N}_{ss \_ set}^{slot}} ⌋ ,$$

where represents the R_{symb}^{PDSCH_sib1} number of symbols to be reserved for the PDSCH. By way of example, index 1 in Table 13-11 in TS 38.213 (multiplexing pattern 1) is configured,

$${N}_{s y m b}^{C O R E S E T} = 1 , {R}_{s y m b}^{PDSCH \_ sib 1} = 6 , {K}_{intra - slot} = ⌊ \frac{14 - 6}{1 * 2} ⌋ = 4 ,$$

the repetition occasions may be shown in FIG. 6B. In this case, the first device 110 may monitor the set of repetitions on the repetition occasions shown in FIG. 6B. The second device 120 may transmit the set of repetitions on the repetition occasions shown in FIG. 6B.

In a further example embodiment, the first device 110 may determine the transmission resources for the set of repetitions of the PDCCH based on the number of symbols per slot, the number of symbols related to a control resource set of the PDCCH, the number of search space sets, the number of symbols to be reserved, and an index of an SSB. For example, the repetition factor (Kᵢ^{intra-slot}, i∈{0,1} Search space set in slot) can be determined as follows:

$$\{ \begin{matrix}\begin{matrix}⌊ \frac{{N}_{symb}^{slot}}{{N}_{s y m b}^{C O R E S E T} {N}_{{ss}_{set} ,}^{slot}} ⌋ + \\ ⌊ \frac{{N}_{symb}^{slot} - ⌊ \frac{{N}_{symb}^{slot}}{{N}_{s y m b}^{C O R E S E T} {N}_{{ss}_{set} ,}^{slot}} ⌋ {N}_{s y m b}^{C O R E S E T} {N}_{{ss}_{set} ,}^{slot}}{{N}_{s y m b}^{C O R E S E T}} ⌋\end{matrix} , i = 0 \\ ⌊ \frac{{N}_{symb}^{slot}}{{N}_{s y m b}^{C O R E S E T} {N}_{{ss}_{set} ,}^{slot}} ⌋ , i = 1\end{matrix}$$

where N_{symb}^{slot} denotes the number of symbols per slot (such as 14), N_{symb}^{CORESET} denotes the number of symbols for CORESET0 in Table 13-1 through 13-10 in TS 38.213, N_{ss_set}^{slot} denotes the number of search space set in Table 13-11 through 13-12a in Table 38.213.

As an example, index 1 in Table 13-11 is configured,

$${N}_{s y m b}^{C O R E S E T} = 2 , {K}_{0}^{intra - slot} = ⌊ \frac{14}{2 * 2} ⌋ + ⌊ \frac{14 - 3 * 2 * 2}{2} ⌋ = 4 ,$$

$${K}_{1}^{intra - slot} = ⌊ \frac{14}{2 * 2} ⌋ = 3 ,$$

the repetition occasion may be shown in FIG. 6C. In this case, the first device 110 may monitor the set of repetitions on the repetition occasions shown in FIG. 6C. The second device 120 may transmit the set of repetitions on the repetition occasions shown in FIG. 6C. As another example, index 1 in Table 13-11 is configured,

$${N}_{s y m b}^{C O R E S E T} = 3 , {K}_{0}^{intra - slot} = ⌊ \frac{14}{2 * 3} ⌋ + ⌊ \frac{14 - 2 * 2 * 3}{3} ⌋ = 2 ,$$

$${K}_{1}^{intra - slot} = ⌊ \frac{14}{2 * 3} ⌋ = 2 ,$$

the repetition occasion may be shown in FIG. 6D. In this case, the first device 110 may monitor the set of repetitions on the repetition occasions shown in FIG. 6D. The second device 120 may transmit the set of repetitions on the repetition occasions shown in FIG. 6D.

In an example embodiment, the transmission resources for the set of repetitions of the PDCCH may be predefined. For example, in order to allow enough symbols for transmission of SIB1 conveyed in PDSCH scheduled by a Type0-PDCCH, a minimal number of 2 repetitions is proposed. In some example embodiments, the predefined transmission resources may be defined in time domain in terms of a starting symbol index within a slot, as shown in way of example in Table 1. Alternatively, the first device 110 may determine the transmission resources for the set of repetitions of the PDCCH based on a starting symbol index of the PDCCH within a slot and a time domain offset. In this latter case, the first device 110 may determine the time domain offset based on a number of symbols related to a search space set of the PDCCH. In some embodiments, the slot may be a same slot of the PDCCH initial transmission (or also referred simply to as the PDCCH in this application). Alternatively, the slot may be a next consecutive slot to the slot of the PDCCH (i.e., the slot where the initial transmission of the PDCCH is received/transmitted). In some other example embodiments, the slot may be a previous slot to the slot of the PDCCH.

In an example embodiment, (such as, for the multiplexing pattern 3) the starting symbol index within the slot may be 0. Alternatively, the starting symbol index within the slot may be 12. In another example embodiment, the staring symbol index within the slot may be 2. In a further example embodiment, the staring symbol index within the slot may be 10. In an example embodiment, the starting symbol index within the slot is 7.

In another example embodiment, the starting symbol index within the slot may be equal to the number of symbols related to a search space set of the PDCCH (i.e. to the number of symbols of the CORESET associated to the search space set of the PDCCH). For example, for the multiplexing pattern 1, if there is only one repetition of the PDCCH and one CSS within the slot, the repetition of the PDCCH may transmit/receive right after the initial transmission of the PDCCH. Alternatively, if there is only one repetition of the PDCCH and two CSS within the slot, the starting symbol index within the slot may be equal to two times the number of symbols related to a search space set of the PDCCH. In a further example embodiment, the starting symbol index within the slot may be the same as a starting symbol index of an initial transmission of the PDCCH.

In some example embodiments, extended time domain resource may be used for the set of repetition of the PDCCH. The repetition occasions associated specific SSB may be in a slot with a periodic way where each repetition occasion may include a number of symbols. The periodicity and the number of symbols may depend on the configuration. For example, for the SSB and CORESET0 multiplexing pattern 1, i.e., Table 13-11, 13-12 and 13-12A, there may be 1 CSS set per slot (for example, FIG. 4A) or 2 CSS set per slot with consecutive occupation (for example, FIG. 4B). The starting symbol index for the repetitions may have a time domain offset based on the original CSS set. The time domain offset may depend on the number of symbols of associated CORESET0 and the number of CSS sets in the slot. For example, Bⱼ^{ss_set,k}=B₀^{ss_set,k}+Oⱼ^{ss_set,k}N_{ss_set}^{slot}*j where B₀^{ss_set,k}=B₀^{ss_set,k}+N_{symb}^{CORESET}*k, k∈{0, 1, . . . , N_{ss_set}^{slot}−1}, j∈{0, 1, . . . , K−1}, K is repetition factor and Oⱼ^{ss_set,k}=N_{symb}^{CORESET}. By way of example, index 0 in Table 13-11 in TS 38. 213, N_{ss_set}^{slot}=1, k=0, N_{symb}^{CORESET}=2, Oⱼ^{ss_set,k}=N_{symb}^{CORESET}=2, B₀^{ss_set,0}=0, B₁^{ss_set,0}=0+2*1*1=2, B₂^{ss_set,k}=0+2*1*2=4, B₃^{ss_set,k}=0+2*1*3=6, the starting symbol index corresponding CSS Sⱼ^{ss_set,k} may be {0,2,4,6} and the time domain offset may be {2}, as shown in FIG. 6E. As another example, index 1 in Table 13-11 in TS 38.213, N_{ss_set}^{slot}=2, N_{symb}^{CORESET}=2, Bⱼ^{ss_set,k} may be determined as following table. The starting symbol indexes may be as shown in FIG. 6F. For example, the starting symbol indexes of the first CCS set for the repetitions may be {0, 4, 8} and the starting symbol indexes of the second CCS set for the repetitions may be {2, 6, 10}.

| | j | | |
|---|---|---|---|
| k | 0 | 1 | 2 |
| 0 | B₀^{ss}_set,0 = | B₁^{ss}_set,0 = | B₂^{ss}_set,0 = 0 + 2 * |
| | 0 | 0 + 2 * 2 * | 2 * 2 = 8 |
| | | 1 = 4 | |
| 1 | B₀^{ss}_set,1 = | B₁^{ss}_set,1 = | B₂^{ss}_set,1 = 2 + 2 * 2 * |
| | 0 + 2 * 1 = | 2 + 2 * 2 * | 2 = 10 |
| | 2 | 1 = 6 | |

In some example embodiments, there is another search space set corresponding to another PDCCH within a slot. In this case, the first device 110 may determine another starting symbol index of the other PDCCH based on the starting symbol index of the PDCCH, a further time domain offset, and the number of search space sets within the slot. For example, the configuration in Table 13-12 and 13-12A for the SSB and CORESET0 multiplexing pattern 1, the starting symbol index for repetitions may have a time offset based on the original CSS set, and the time offset may depend on the number of symbols of associated CORESET0 and the number of CSS set in a slot. For example, Bⱼ^{ss_set,k}=B₀^{ss_set,k}+Oⱼ^{ss_set,k}*j, where B₀^{ss_set,k}=0, B₀^{ss_set,k}=7, k∈{0,1}, j∈{0, 1, . . . , K−1}, K represents a repetition factor, Oⱼ^{ss_set,k}=N_{symb}^{CORESET}. By way of example, index 1 in Table 13-12 in TS 38.213 is configured, N_{ss_set}^{slot}=2, N_{symb}^{CORESET}=2, Bⱼ^{ss_set,k} may be determined as following table The starting symbol indexes may be as shown in FIG. 6G. For example, the starting symbol indexes of the first CCS set for the repetitions may be {0, 2} and the starting symbol indexes of the second CCS set for the repetitions may be {7, 9}.

| | j | |
|---|---|---|
| k | 0 | 1 |
| 0 | B₀^{ss}_set,0 = 0 | B₁^{ss}_set,0 = 0 + 2 * 1 = 2 |
| 1 | B₀^{ss}_set,1 = 7 | B₁^{ss}_set,1 = 7 + 2 * 1 = 9 |

In some other example embodiments, the first device 110 may determine a set of time domain resources a set of time domain resources for an initial transmission of the PDCCH as the transmission resource for the set of repetitions of the PDCCH. By way of example, a set of symbols before the set of symbols for the initial transmission. For example, the configuration in Table 13-15 and 13-15A in TS 38. 213 for the SSB and CORESET0 multiplexing pattern 3, the repetitions may be minimized as 2 to reserve resource for PDSCH where convey SIB1. The starting symbol index for repetitions may have a time domain offset based on the original CSS set. The time domain offset may be depending on the number of symbols associated CORESET0 and the number of CSS set in a slot. As an example, the range of symbol index is [0, 27] which contains 2 PDCCH slots for Table 13-15, and [0, 13] which contains 1 PDCCH slot for Table 13-15A.

In an example embodiment, the starting symbol index within the slot is 0, 2, 0 in i=4k, i=4k+1, i=4k+3, where k∈{0, 1, . . . , 15}, in the same slot as corresponding SSB with index i, i.e., n_{c}=n_{SSB,i}, and 12 in i=4k+2 in the previous slot i.e., n_{c}=n_{SSB,i}−1. In one example, N_{ss_set}^{slot}=2, N_{symb}^{CORESET}=2, Bⱼ^{ss_set,k} may be determined as following table. The starting symbol indexes may be as shown in FIG. 6H. For example, the starting symbol indexes of the first CCS set for the repetitions may be {2, 0} and the starting symbol indexes of the second CCS set for the repetitions may be {9, 7}.

| | j | |
|---|---|---|
| k | 0 | 1 |
| 0 | B₀^{ss}_set,0 = 2 | B₁^{ss}_set,0 = 2 − 2 * 1 = 0 |
| 1 | B₀^{ss}_set,1 = 2 + 7 + 2 * 2 * | B₁^{ss}_set,1 = 9 − 2 * 1 = 7 |
| | 0 = 9 | |

In another example embodiment, the starting symbol index within the slot is 0, 7 in i=2k, i=2k+1 where k∈{0, 1, . . . , 31}, in the same slot as corresponding SSB with index i, i.e., n_{c}=n_{SSB,i}. In another example, Table 13-15A, N_{ss_set}^{slot}=4, N_{symb}^{CORESET}=2, K=2,Bⱼ^{ss_set,k} may be determined as following table. The starting symbol indexes may be as shown in FIG. 6I. For example, the starting symbol indexes of the first CCS set for the repetitions may be {4, 0}, the starting symbol indexes of the second CCS set for the repetitions may be {8, 2}, the starting symbol indexes of the third CCS set for the repetitions may be {16, 12}, the starting symbol indexes of the fourth CCS set for the repetitions may be {20, 14}.

| | j | |
|---|---|---|
| k | 0 | 1 |
| 0 | B₀^{ss}_set,0 = 4 | B₁^{ss}_set,0 = 4 − 2 * 2 = 0 |
| 1 | B₀^{ss}_set,1 = 4 + 2 * 2 * 1 = 8 | B₁^{ss}_set,1 = 8 − 2 * 3 = 2 |
| 2 | B₀^{ss}_set,2 = 4 + 12 + | B₁^{ss}_set,2 = |
| | 2 * 2 * 0 = 16 | 16 − 2 * 2 = 12 |
| 3 | B₀^{ss}_set,2 = 4 + 12 + 2 * 2 * | B₁^{ss}_set,3 = 20 − 2 * |
| | 1 = 20 | 3 = 14 |

In some example embodiments, the first device 110 may determine a set of frequency domain resources that is different from a set of frequency domain resources for the initial transmission of the PDCCH as the transmission resources for the set of repetitions of the PDCCH. For example, the transmission resources may be defined in frequency domain in terms of a frequency offset from a reference point in frequency domain. In some example embodiments, the reference point in frequency domain is a frequency location of a synchronization signal physical broadcast channel block. Alternatively, the reference point may be a frequency location of a control resource set of the PDCCH. The term “frequency location” used herein may refer to one of: a lowest frequency of the reference point, a highest frequency of the reference point, or a center frequency of the reference point.

In an example embodiment, the frequency offset may be predefined so that the transmission resources are at a lower frequency than a frequency of the reference point. In other words, the frequency resource which frequency is lower than original CORESET0 and within the same occasion of original CORESET0 may be used to extend for repetition, e.g., for the SSB and CORESET0 multiplexing pattern 2, i.e., Table 13-7 and 13-10. In one implementation, the starting symbol for repetition may be the same as original, i.e., Bⱼ^{ss_set,k}=B₀^{ss_set,k}, and B₀^{ss_set,k}, is determined by Table 13-13 or 13-14 in TS 38. 213. In one implementation, the reserved indexes in Table 13-13 and 13-14 can be used to extend the CORESET0 for the repetitions.

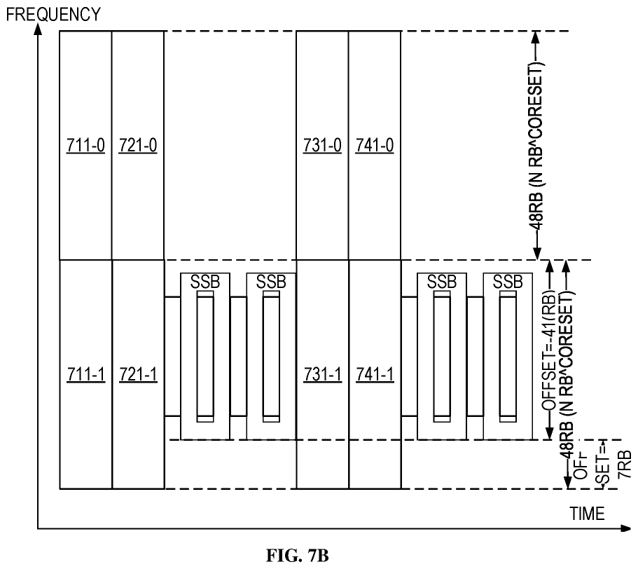

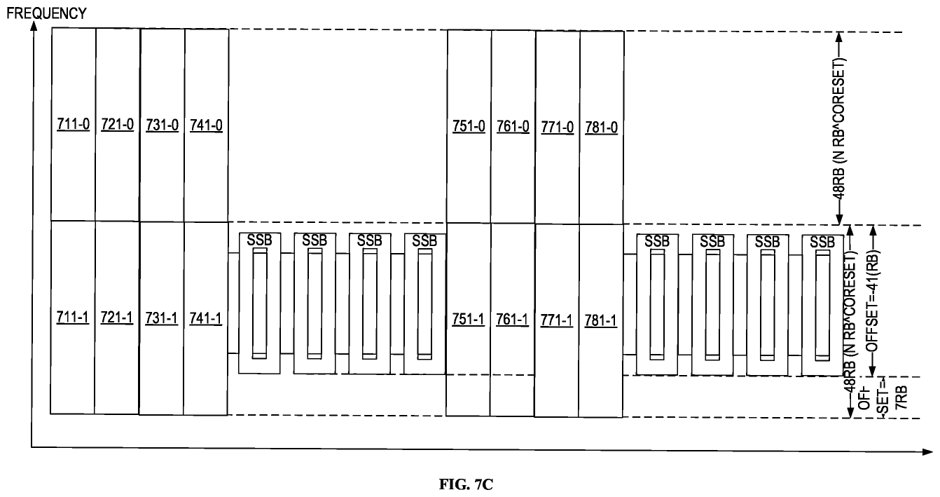

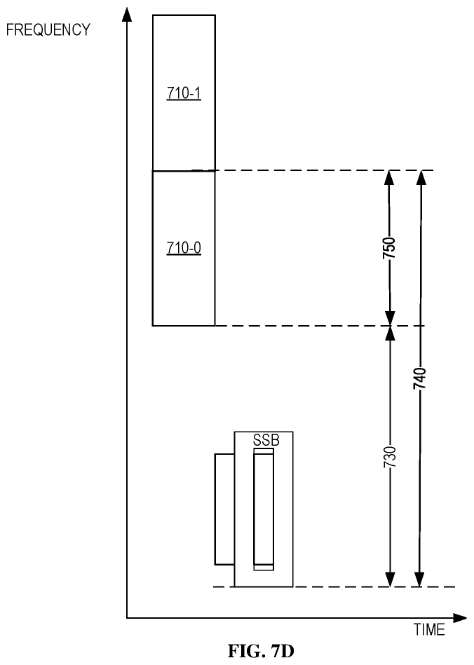

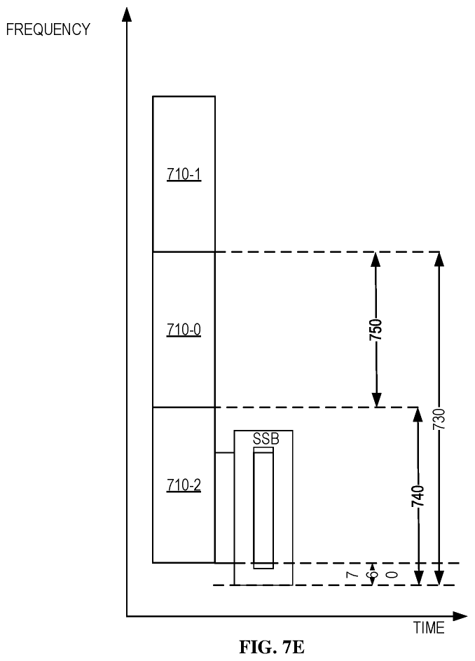

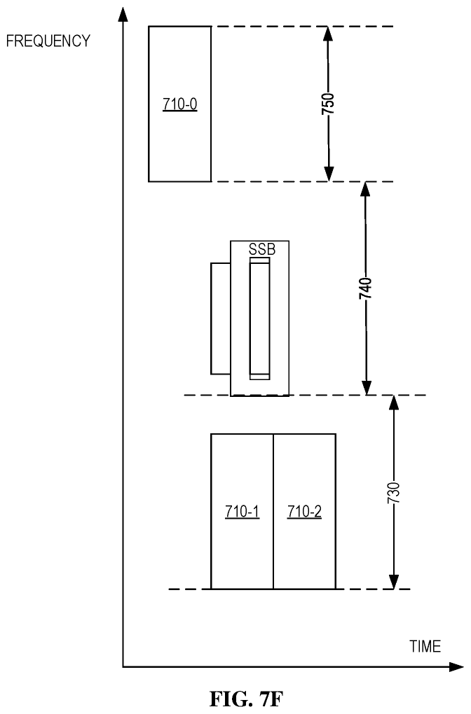

In another example embodiment, the original indexes from 8 to 11 where contain the configuration of multiplexing pattern 2 can be expanded to support extending CORESET0 for Type0-PDCCH repetition. In this way, it can support fallback with the Type 2 UEs automatically since Type 2 UEs are able to skip the extended CORESET0. The extended CORESET0 710-1 and the associated offset is depicted in FIG. 7A. In terms of offset of extended CORESET0, as shown in FIG. 7A, it can be denoted as Offset₂=Offset₁+N_{RB}^{CORESET0}, where Offset₁ and N_{RB}^{CORESET0} are the Offset and N_{RB}^{CORESET0} in the Table 13-13 or 13-14 in TS 38. 213 and Offset₁ may be a negative value. That is, as shown in FIG. 7A, the offset 730 (i.e., Offset₂)=offset 740 (i.e., Offset₁)+the number of resource blocks 750 for the CORESET 0 710-0 (i.e., N_{RB}^{CORESET0}).

In an example embodiment, N_{ss_set}^{slot}=4, N_{symb}^{CORESET}=1, B₀^{ss_set,0}, k∈{0,1,2,3}, in addition to the original CORESET0 (CORESET0 711-0, 721-0, 731-0, and 741-0), the function of indices from 8 to 11 may be expended to configure an additional CORESET0 (CORESET0 711-1, 721-1, 731-1 and 741-1) that is dedicated for Type-PDCCH repetition, as shown in FIG. 7B. The time domain offsets may be determined based on the following table.

TABLE 13-7
Set of resource blocks and slot symbols of CORESET for Type0-PDCCH
search space set when {SS/PBCH block, PDCCH} SCS is {120, 60} kHz

| | SS/PBCH block | | | | |
|---|---|---|---|---|---|
| | and CORESET | Number of | Number of | | |
| | multiplexing | RBs | Symbols | Number of | |
| Index | pattern | N_{RB}^{CORESET} | N_{symb}^{CORESET} | CORESET | Offset (RBs) |
| 0 | 1 | 48 | 1 | 1 | 0 |
| 1 | 1 | 48 | 1 | 1 | 8 |
| 2 | 1 | 48 | 2 | 1 | 0 |
| 3 | 1 | 48 | 2 | 1 | 8 |
| 4 | 1 | 48 | 3 | 1 | 0 |
| 5 | 1 | 48 | 3 | 1 | 8 |
| 6 | 1 | 96 | 1 | 1 | 28 |
| 7 | 1 | 96 | 2 | 1 | 28 |
| 8* | 2 | 48 | 1 | 2 | For CORESET0: |
| | | | | | −41 if k_{SSB} = 0, −42 |
| | | | | | if k_{SSB} > 0 |
| | | | | | For extended |
| | | | | | CORESET0: |
| | | | | | 7 if k_{SSB} = 0, 6 if |
| | | | | | k_{SSB} > 0 |
| 9* | 2 | 48 | 1 | 2 | For CORESET0: 49 |
| | | | | | For extended |
| | | | | | CORESET0:97 |
| 10* | 2 | 96 | 1 | 2 | For CORESET0: |
| | | | | | −41 if k_{SSB} = 0, −42 |
| | | | | | if k_{SSB} > 0 |
| | | | | | For extended |
| | | | | | CORESET0: |
| | | | | | 55 if k_{SSB} = 0, 54 if |
| | | | | | k_{SSB} > 0 |
| 11* | 2 | 96 | 1 | 2 | For CORESET0: 97 |
| | | | | | For extended |
| | | | | | CORESET0: 195 |

| | |
|---|---|
| 12-15 | Reserved |

In another example, N_{ss_set}^{slot}=8, N_{symb}^{CORESET}=1, B₁^{ss_set,k}=B₀^{ss_set,0}, k∈{0,1,2,3,4,5,6,7}, in addition to the original CORESET0 (CORESET0 711-0, 721-0, 731-0, 741-0, 751-0, 761-0, 771-0, 781-0), the function of indices from 4 to 7 may be expended to configure an additional CORESET0 (CORESET0 711-1, 721-1, 731-1, 741-1, 75 1-1, 761-1, 771-1, 781-1) that is dedicated for Type-PDCCH repetition as shown in FIG. 7C.

TABLE 13-10
Set of resource blocks and slot symbols of CORESET for Type0-PDCCH
search space set when {SS/PBCH block, PDCCH} SCS is {240, 120} kHz

| | SS/PBCH block | | | | |
|---|---|---|---|---|---|
| | and CORESET | Number of | Number of | | |
| | multiplexing | RBs | Symbols | Number of | |
| Index | pattern | N_{RB}^{CORESET} | N_{symb}^{CORESET} | CORESET | Offset (RBs) |
| 0 | 1 | 48 | 1 | 1 | 0 |
| 1 | 1 | 48 | 1 | 1 | 8 |
| 2 | 1 | 48 | 2 | 1 | 0 |
| 3 | 1 | 48 | 2 | 1 | 8 |
| 4* | 2 | 24 | 1 | 2 | For CORESET0: |
| | | | | | −41 if k_{SSB} = 0, −42 |
| | | | | | if k_{SSB} > 0 |
| | | | | | For extended |
| | | | | | CORESET0: |
| | | | | | −17 if k_{SSB} = 0, −18 |
| | | | | | if k_{SSB} > 0 |
| 5* | 2 | 24 | 1 | 2 | For CORESET0: 5 |
| | | | | | For extended |
| | | | | | CORESET0: 49 |
| 6* | 2 | 48 | 1 | 2 | For CORESET0: |
| | | | | | −41 if k_{SSB} = 0, |
| | | | | | −42 if k_{SSB} > 0 |
| | | | | | For extended |
| | | | | | CORESET0: |
| | | | | | 7 if k_{SSB} = 0, 6 if |
| | | | | | k_{SSB} > 0 |
| 7* | 2 | 48 | 1 | 2 | For CORESET0: 49 |
| | | | | | For extended |
| | | | | | CORESET0: 97 |

| | |
|---|---|
| 8-15 | Reserved |

In some example embodiments, the frequency offset may be predefined so that the transmission resources are at a higher frequency than a frequency of the reference point. For example, the extended CORESET0 710-1 and the associated Offset is depicted in FIG. 7D). In terms of offset of extended CORESET0, it can be denoted as Offset₂=Offset₁−N_{RB}^{CORESET0}, where Offset, and N_{RB}^{CORESET0} are the Offset and N_{RB}^{CORESET0} in the Table 13-13 or 13-14 in TS 38. 213. That is, as shown in FIG. 7D), the offset 730 (i.e., Offset₂)=offset 740 (i.e., Offset₁)—the number of resource blocks 750 for the CORESET 0 710-0 (i.e., N_{RB}^{CORESET0}).

In some example embodiments, the frequency offset is predefined in units of resource blocks and is indicated by a reserved value of a control resource set 0 in a parameter pdcch-ConfigSIB1. Alternatively, a size of the transmission resources in frequency domain is the same as that of the CORESET0.

In some example embodiments, a first set of the transmission resources is defined in terms of a first frequency offset from a frequency location of a control resource set of the PDCCH, and a second set of the transmission resources is defined in terms of a second frequency offset from the frequency location of a control resource set of the PDCCH. In some example embodiments, the first frequency offset is predefined so that the first set of transmission resources are at a lower frequency than the frequency location of the control resource set of the PDCCH, and the second frequency offset is predefined so that the second set of transmission resources are at a higher frequency than the frequency location of the control resource set of the PDCCH. For example, the extended CORESET0 710-1 and 710-2 and associated Offsets are depicted in FIG. 7E. In terms of offset of extended CORESET0, it can be denoted as Offset₂=Offset₁−N_{CORESET0}, Offset₃=Offset₁+N_{RB}^{CORESET0}, where Offset₁ and N_{RB}^{CORESET0} are the Offset and N_{RB}^{CORESET0} in the Table 13-13 or 13-14. That is, as shown in FIG. 7E, the offset 730 (i.e., Offset₂)=offset 740 (i.e., Offset₁)−the number of resource blocks 750 for the CORESET 0 710-0 (i.e., N_{RB}^{CORESET0}), and the offset 760 (i.e., Offset₃)=offset 740 (i.e., Offset₁)+the number of resource blocks 750 for the CORESET 0 710-0 (i.e., N_{RB}^{CORESET0})

In yet another embodiment, the transmission resources may be at lower frequency than the frequency location of the SSB. For example, the other frequency resource which frequency is lower than (below) associated SSB and within the same occasion of associated SSB where it is not for transmission of SIB1 can be extended for Type0-PDCCH repetitions, e.g., there are 2 extended CORESET0 (710-1 and 710-2) and associated Offset which are depicted in FIG. 7F.

In some example embodiments, the repetitions including the intra-slot repetitions and/or repetitions across two consecutive slots and the inter-slot repetitions may coexist. In this case, the first device 110 may determine an inter-slot repetition factor for an inter-slot repetition of the PDCCH. The first device 110 may determine the inter-slot repetition factor for the PDCCH based on a configured repetition factor and the repetition factor for the repetitions.

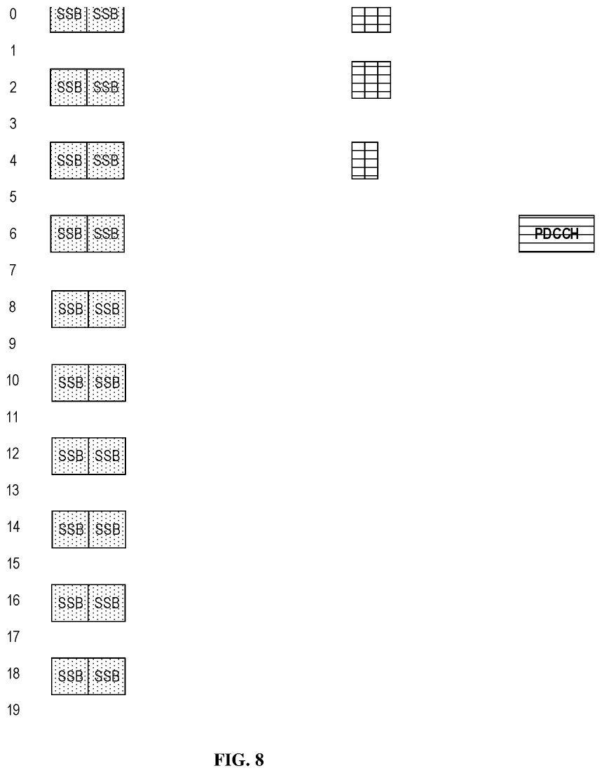

For example, for SSB/CORESET0 multiplexing pattern 1, the inter-slot repetition factor and slot occasion list can denote as N and (n_{c}⁰, n_{c}¹, . . . , n_{c}^{N-1}). In one embodiment, the inter-slot repetition factor (N) can be derived from configured repetition factor (K_{c}) and determined repetition factor (Kᵢₙₜᵣₐ₋ₛₗₒₜ), N=┌K_{c}/Kᵢₙₜᵣₐ₋ₛₗₒₜ┐. For example, K_{c}=8, Kᵢₙₜᵣₐ₋ₛₗₒₜ=3, N=┌8/3┐=3, the repetition pattern is shown as FIG. 8.

In some example embodiments, the first device 110 may determine a repetition occasion for an inter-slot repetition of the PDCCH based on the inter-slot repetition factor. In one embodiment, the repetition occasion may be determined based on the inter-slot repetition factor that considers coexistence with the repetitions, for example, if there is only 1 slot occasion per SFN, the repetition occasions can be denoted as (n₀^{SFN}^{ₛₜₐᵣₜ}+x, n₀^{SFN}^{ₛₜₐᵣₜ₊₂}+x, . . . , n₀^{SFN}^{_{start+2*N}}+x), where n₀^{SFN}^{ₛₜₐᵣₜ}+x represents slot n₀+x in a frame of SFNₛₜₐᵣₜ, n₀^{SFN}^{_{start+2*N}}+x represents slot n₀+x in a frame of SFNₛₜₐᵣₜ+2*N, and so on. where x may be 0, 1, 4 or 8 depending on the Sub-carrier Spacing (SCS) value y as described above, N is the inter-slot repetition factor which is ┌K_{c}/Kᵢₙₜᵣₐ₋ₛₗₒₜ┐.

In another embodiment, the repetition occasion may be determined based on the inter-slot repetition factor that considers coexistence with the repetitions, for example, if there are 2 slot occasions per SFN and n₀+x is not overlapped with the slot of the next SSB index,

$$\{ \begin{matrix}\begin{matrix}( {n}_{0}^{S F {N}_{s t a r t}} , {n}_{0}^{S F {N}_{s t a r t}} + x , … … , {n}_{0}^{S F {N}_{start} + ( ⌈ \frac{N}{2} ⌉ - 1 ) * 2} , \\ {n}_{0}^{S F {N}_{s t a r t} + ( ⌈ \frac{N}{2} ⌉ - 1 ) * 2} + x ) , N is even\end{matrix} \\ \begin{matrix}( {n}_{0}^{S F {N}_{s t a r t}} , {n}_{0}^{S F {N}_{s t a r t}} + x , {n}_{0}^{S F {N}_{s t a r t} + 2} , \\ {n}_{0}^{S F {N}_{s t a r t} + 2} + x , … … , {n}_{0}^{S F {N}_{s t a r t} + ( ⌈ \frac{N}{2} ⌉ - 1 ) * 2} ) , N is odd\end{matrix}\end{matrix} ,$$

where

$${n}_{0}^{SF {N}_{s t a r t} + ( ⌈ \frac{N}{2} ⌉ - 1 ) * 2}$$

is the n₀ in frame of

$$S F {N}_{start} + ( ⌈ \frac{N}{2} ⌉ - 1 ) * 2 ,$$

x may be 1, 4 or 8 depending on the Sub-carrier Spacing (SCS) value μ as described above, N is the inter-slot repetition factor which is ┌K_{c}/Kᵢₙₜᵣₐ₋ₛₗₒₜ┐.

In some example embodiments, the first device 110 may determine a starting frame of a repetition occasion for an inter-slot repetition of the PDCCH by: (SFNₛₜₐᵣₜ−SFN_{reference}) mod (M×2)=0, where N represents the inter-slot repetition factor, M=N if there is only 1 slot occasion per system frame number or

$$M = ⌈ \frac{N}{2} ⌉$$

if there is only 2 slot occasions per system frame number (SFN), SFN_{reference} represents SFN₀ for synchronization signal block indices in even system frame numbers or SEN₁ for synchronization signal block indices in odd system frame numbers. For example, depending on the inter-slot repetition factor that considers coexistence with the repetitions, the starting frame number may be determined as the SFNₛₜₐᵣₜ satisfying: (SFNₛₜₐᵣₜ−SFN_{reference}) mod (M×2)=0, where M=N if there is only 1 slot occasion per SFN or

$$M = ⌈ \frac{N}{2} ⌉$$

if there is only 2 slot occasions per SFN. SFN_{reference} may be SFN₀ (or SFN=0) for SSB indices with PDCCH monitoring occasions (PMO)s in even SFNs or SFN₁ (or SFN=1) for SSB indices with PMOs in odd SFNs, N is the inter-slot repetition factor which is ┌K_{c}/Kᵢₙₜᵣₐ₋ₛₗₒₜ┐. The “PMO” used herein may refer to a set of resources that is used to monitor the PDCCH.

In some other example embodiments, the first device 110 may determine a repetition occasion is in a same slot of a synchronization signal block corresponding to the PDCCH. For example, for SSB/CORESET0 multiplexing pattern 2/3, the CORESET0 occasion may be in the same slot of SSB according to Table 13-13 through 13-15A, i.e., SFN_{c}=SFN_{SSB,i}, n_{c}=n_{SSB,i} or n_{c}=n_{SSB,i}−1, SFNₛₜₐᵣₜ and n_{c}^{SFN}^{_{Start}} denote starting SFN/slot for Type0-PDCCH repetition. In one embodiment, the inter-slot repetition factor (N) can be derived from the configured repetition factor (K_{c}) and determined repetition factor (Kᵢₙₜᵣₐ₋ₛₗₒₜ), N=┌K_{c}/Kᵢₙₜᵣₐ₋ₛₗₒₜ┐.

Alternatively, the first device 110 may determine a repetition occasion is in a previous slot of a synchronization signal block corresponding to the PDCCH. Each repetition slot of the inter-slot repetition may include the same number of the repetitions including intra-repetitions and/or repetitions across two consecutive slots. In another embodiment, in terms of determination of Kᵢₙₜᵣₐ₋ₛₗₒₜ which satisfying K_{c} mod Kᵢₙₜᵣₐ₋ₛₗₒₜ=0, in other words, each repetition slot may include the same number of intra-slot repetitions, therefore, the first device 110 can start to monitor the repetition occasion from any potential occasion because of no ambiguity. For example, K_{c}=8, Kᵢₙₜᵣₐ₋ₛₗₒₜ should be even integer number, e.g., Kᵢₙₜᵣₐ₋ₛₗₒₜ=2, thus each repetition occasion slot contains 2 repetitions, the first device 110 can start monitor and receive from any repetition occasion.

In some example embodiments, the first device 110 may determine, based on a repetition occasion, an inter-slot repetition factor and the number slot in a system frame number, a repetition slot pattern for the inter-slot repetition of the PDCCH. In yet another embodiment, the repetition slot pattern can be denoted by {n_{c}, n_{c}+2Nₛₗₒₜ^{frame}, n_{c}+4Nₛₗₒₜ^{frame,μ}, . . . , n_{c}+2(N−1)Nₛₗₒₜ^{frame,μ}}, where Nₛₗₒₜ^{frame,μ}, is the number slot per frame in given μ (Table 4.3.2-1 in TS 38.211).

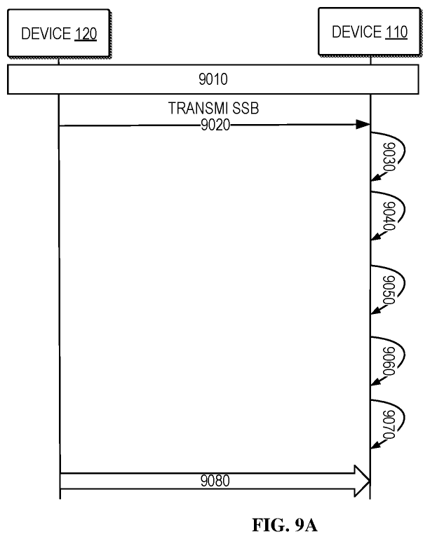

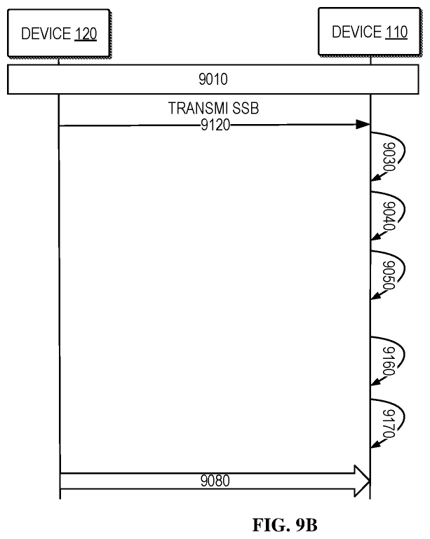

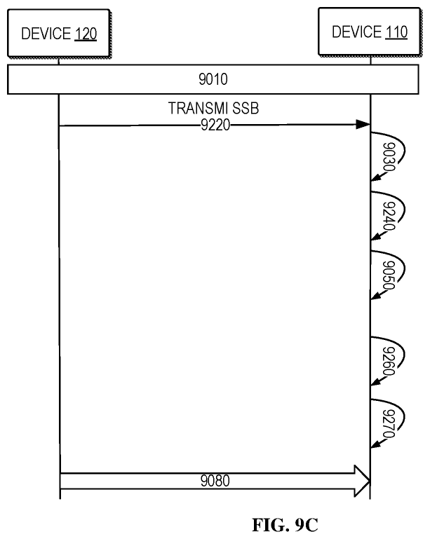

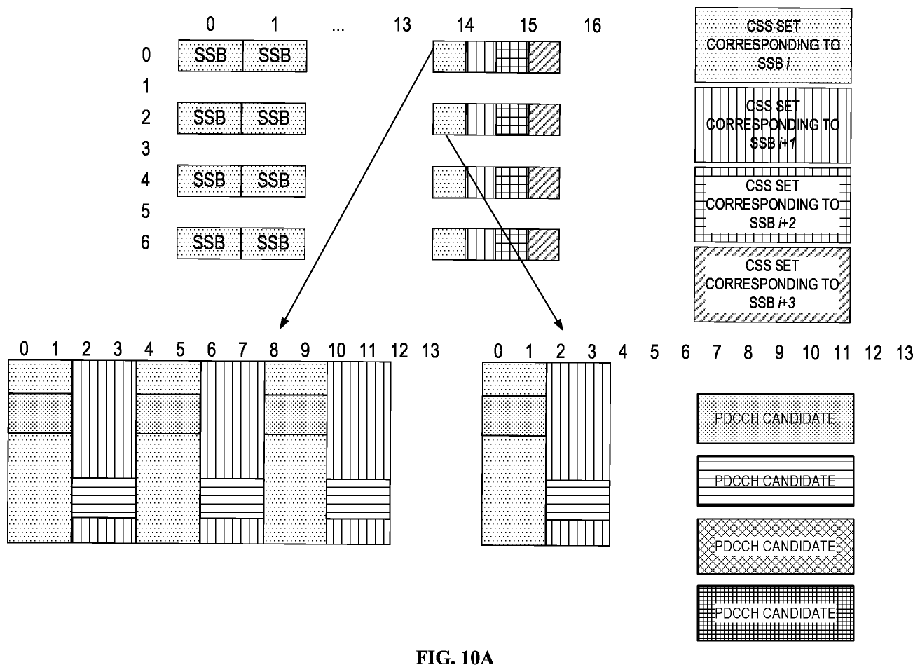

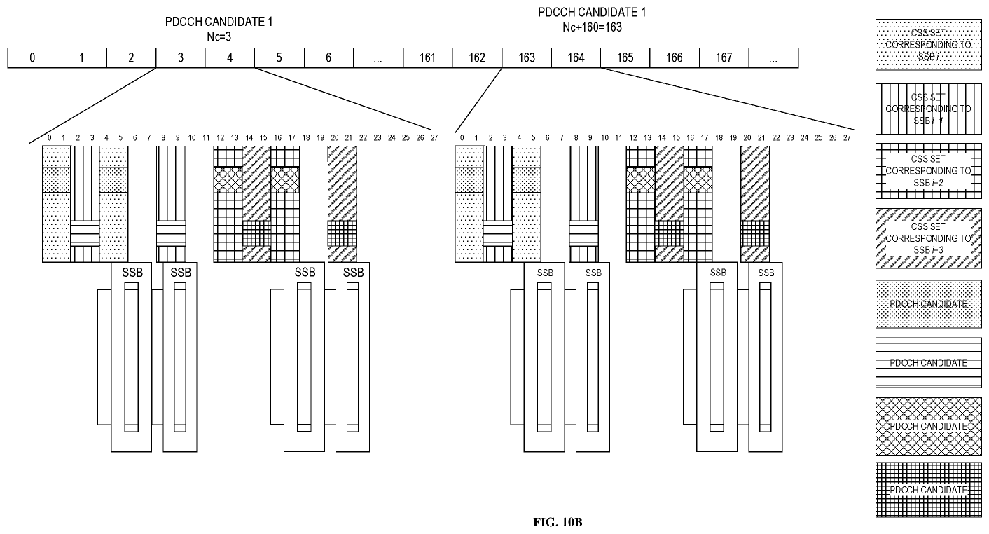

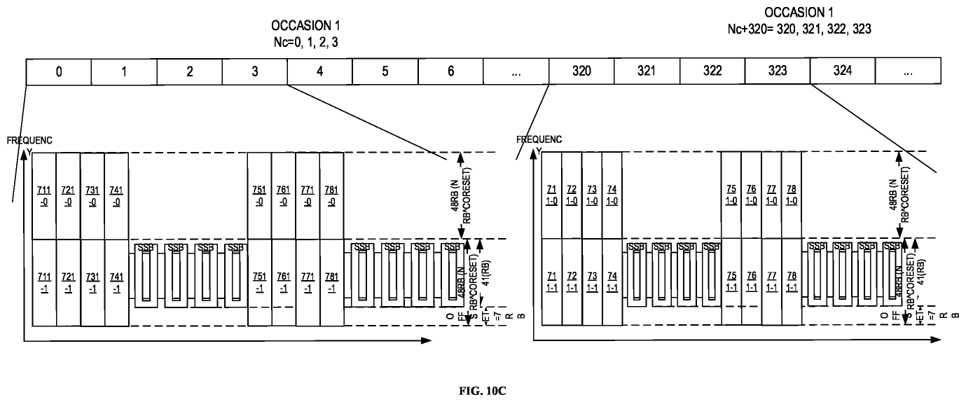

FIG. 9A to FIG. 9C show signaling charts for communication according to some example embodiments of the present disclosure. As shown in FIG. 9A to FIG. 9C, the signaling charts involve a first device 110, and a second device 120. For the purpose of discussion, reference is made to FIG. 1 and FIG. 10A to FIG. 10C to describe the signaling chart 200. Only for the purpose of illustrations, FIG. 9A to FIG. 9C are described with reference to intra-slot repetitions. It is noted that FIG. 9A to FIG. 9C are also applicable to repetitions across two consecutive slots.

As shown in FIG. 9A, the second device 120 may configure (9010) a repetition factor, CORESET0 and CSS via ssb-SubcarrierOffset (k_ssb), ControlResourceSetZero and SearchSpaceZero in MIB. In other word, the first device 110 may obtain the MIB from the second device 120.

The second device 120 may transmit (9020) a PSS/SS/PBCH block (SSB) with k_ssb=30, ControlResourceSetZero being set as ‘1000’, SearchSpaceZeroset being as ‘1001’. In this case, 2 most significant bits (MSBs) of ControlResourceSetZero is set to ‘10’, which can indicate the repetition factor is 4 and 2 least significant bits (LSBs) of ControlResourceSetZero is set to ‘00’, which means CORESET configuration index=0. Further, 1MSB of SearchSpaceZeroset is set to ‘1’, which means that repetition is activated, and 3LSB of SearchSpaceZeroset is set to ‘111’, which means that Search Space configuration index=7.

The first device 110 may perform (9030) a band scan and get a synchronization with gNB, e.g., frequency and frame synchronization. The first device 110 which is Type 1 UE may obtain (9040) that the intra-slot and inter-slot repetition activated for the first device 110, the repetition factor is 4, and the frequency domain offset between the first SSB and the overall resource block grid in number of subcarriers is equal to a specified value of 0 subcarriers. Other devices that are Type 2 UEs may understand there is no CORESET0 associated SSB and there is CORESET0 associated second SSB. The first device 110 may determine (9050) frequency domain resources via ControlResourceSetZero and SearchSpaceZero.

The first device 110 may determine (9060) a repetition factor for the repetitions: N_{symb}^{CORESET}=2 (Table 13-4 index 0), N_{ss_set}^{slot}=2, (Table 13-11 index 7 in TS 38.213),

$${K}_{intra - slot} = ⌊ \frac{14}{2 * 2} ⌋ = 3.$$

The first device 110 may further determine (9050) a starting symbol index and an offset of respective search space sets in a slot: Oⱼ^{ss_set,k}=N_{symb}^{CORESET}=2. The starting symbol index may be determined as the following table.

| | j | | |
|---|---|---|---|
| k | 0 | 1 | 2 |
| 0 | B₀^{ss}_set,0 = 0 | B₁^{ss}_set,0 = 0 + 2 * | B₂^{ss}_set,0 = 0 + 2 * 2 * |
| | | 2 * 1 = 4 | 2 = 8 |
| 1 | B₀^{ss}_set,1 = | B₁^{ss}_set, 1 = | B₂^{ss}_set,1 = 2 + 2 * 2 * |
| | 0 + 2 * 1 = | 2 + 2 * 2 * | 2 = 10 |
| | 2 | 1 = 6 | |

The first device 110 may monitor (9070) the Type0-PDCCH repetitions corresponding SFN_{c}/n₀ (PDCCH SFN and Slot) and the starting symbols index/offset. For example, the 4 times repetition occasion locates slot 14 in 2 SFNs, i.e., SFN #0 and 2, the first 3 occasion is in SFN #0 and the latest occasion in SFN #2. The first device 110 may perform (9080) the reception of Type0-PDCCH and corresponding SIB1. The corresponding repetition occasions may be depicted as shown in FIG. 10A.

As shown in FIG. 9B, the second device 120 may configure (9010) a repetition factor, CORESET0 and CSS via ssb-SubcarrierOffset (k_ssb), ControlResourceSetZero and SearchSpaceZero in MIB. In other word, the first device 110 may obtain the MIB from the second device 120.

The second device 120 may transmit (9120) a SS/PBCH block (SSB) with k_ssb=30, ControlResourceSetZero being set as ‘1100’, SearchSpaceZeroset being as ‘1000’. In this case, 1MSB of ControlResourceSetZero set=‘1’, which means that the intra-slot repetition is activated. 3LSB of ControlResourceSetZero=‘100’, which means that CORESET configuration index=4. 2MSB of SearchSpaceZero set=‘10’, which means that repetition factor=4. 2LSB of SearchSpaceZero set=‘00’, which means that Common Search Space Index=0. The first device 110 may perform (9030) a band scan and get a synchronization with the second device 120, e.g., frequency and frame synchronization.

The first device 110 which is Type 1 UE may obtain (9040) the intra-slot and inter-slot repetition activated, the repetition factor is 4, and the frequency domain offset between the first SSB and the overall resource block grid in number of subcarriers is equal to a specified value of 0 subcarriers. Type 2 UE may understand there is no CORESET0 associated SSB and there is CORESET0 associated second SSB.

The first device 110 may determine (9050) frequency domain resources via ControlResourceSetZero and SearchSpaceZero. The first device 110 may determine (9060) the repetition factor for the repetitions: N_{symb}^{CORESET}=2 (Table 13-8 index 4 in TS 38.213), N_{ss_set}^{slot}=4 (Table 13-15 multiplexing pattern 3, SCS{120k, 120k} in TS 38.213),

$${R}_{s y m b}^{PDSCH \_ sib 1} = 6 , {K}_{intra - slot} = ⌊ \frac{( 14 - 6 ) * 2}{2 * 4} ⌋ = 2.$$

The first device 110 may further determine (9050) a starting symbol index and offset of respective search space sets in a slot: Oⱼ^{ss_set,k}=N_{symb}^{CORESET}=2. The starting symbol index may be determined as follows table. The first device 110 may also determine (9050) inter-slot repetition factor

$$N = ⌈ {K}_{c} / {K}_{intra - slot} ⌉ = \frac{4}{2} = 2 ,$$

the slot occasions is {n_{c},n_{c}+160} due to Nₛₗₒₜ^{frame,3}=80 for SCS=120 kHz.

| | j | |
|---|---|---|
| k | 0 | 1 |
| 0 | B₀^{ss}_set,0 = 4 | B₁^{ss}_set,0 = |
| | | 4 − 2 * 2 = 0 |
| 1 | B₀^{ss}_set,1 = 4 + 2 * 2 * 1 = 8 | B₁^{ss}_set,1 = |
| | | 8 − 2 * 3 = 2 |
| 2 | B₀^{ss}_set,2 = 4 + 12 + 2 * 2 * 0 = 16 | B₁^{ss}_set,2 = |
| | | 16 − 2 * 2 = 12 |
| 3 | B₀^{ss}_set,2 = 4 + 12 + 2 * 2 * 1 = 20 | B₁^{ss}_set,3 = |
| | | 20 − 2 * 3 = 14 |

The first device 110 may monitor (9070) Type0-PDCCH repetitions corresponding SFN_{c}/n₀ (PDCCH SFN and Slot) (Step 6-c) and Start Symbols Index/Offset (step 6-b). For example, the 4 times repetition occasion may locate the same slot as associated SSB in 2 frames, i.e., SFN #0 and SFN #1, the first 2 occasions are in first half of SFN #0 and the last 2 occasions in first half SFN #1. The first device 110 may perform (9080) the reception of Type0-PDCCH and corresponding SIB1. The corresponding repetition occasions may be depicted in FIG. 10B.

As shown in FIG. 9C, the second device 120 may configure (9010) a repetition factor, CORESET0 and CSS via ssb-SubcarrierOffset (k_ssb), ControlResourceSetZero and SearchSpaceZero in MIB. In other word, the first device 110 may obtain the MIB from the second device 120.

The second device 120 may transmit (9220) a PSS/SS/PBCH block (SSB) with k_ssb=30, ControlResourceSetZero being set as ‘1110’, SearchSpaceZeroset being as ‘1000’. In this case, 1MSB of ControlResourceSetZero set=‘1’, which means the intra-slot repetition is activated. 3LSB of ControlResourceSetZero ‘110’, which mean CORESET configuration index=6. 2MSB of SearchSpaceZero set=‘10’, which means the repetition factor is 4. 2LSB of SearchSpaceZero set=‘00’, which means Common Search Space Index=0.

The first device 110 may perform (9030) band scan and get a synchronization with gNB, e.g., frequency and frame synchronization. The first device 110 which is Type 1 UE may obtain (9040) that the intra-slot and inter-slot repetition activated for the first device 110, the repetition factor is 4, and the frequency domain offset between the first SSB and the overall resource block grid in number of subcarriers is equal to a specified value of 0 subcarriers. Other devices that are Type 2 UEs may understand there is no CORESET0 associated SSB and there is CORESET0 associated second SSB. The first device 110 may determine (9050) frequency domain resources via ControlResourceSetZero and SearchSpaceZero.

The first device 110 may determine (9260) an intra-slot repetition factor: N_{symb}^{CORESET}=2 (Table 13-10 index 6 in TS 38.213), N_{ss_set}^{slot}=4, (Table 13-14 pattern 2, SCS{240k, 120k} in TS 38.213), Kᵢₙₜᵣₐ₋ₛₗₒₜ=2. The first device 110 may determine (9260) a starting symbol index and offset of respective search space sets in a slot: Oⱼ^{ss_set,k}=N_{symb}^{CORESET}=1. The staring symbol index may be determined as the following table.

| | j | |
|---|---|---|
| k | 0 | 1 |
| 0 | B₀^{ss}_set,0 = 0 | B₁^{ss}_set,0 = 0 |
| 1 | B₀^{ss}_set,1 = 1 | B₁^{ss}_set,1 = 1 |
| 2 | B₀^{ss}_set,2 = 2 | B₁^{ss}_set,2 = 2 |
| 3 | B₀^{ss}_set,2 = 3 | B₁^{ss}_set,2 = 3 |
| 4 | B₀^{ss}_set,4 = 12 | B₁^{ss}_set,4 = 12 |
| 5 | B₀^{ss}_set,5 = 13 | B₁^{ss}_set,5 = 13 |
| 6 | B₀^{ss}_set,6 = 14 | B₁^{ss}_set,6 = 14 |
| 7 | B₀^{ss}_set,7 = 15 | B₁^{ss}_set,7 = 15 |

The first device 110 may determine (9260) an inter-slot repetition factor

$$N = ⌈ {K}_{c} / {K}_{intra - slot} ⌉ = \frac{4}{2} = 2 ,$$

the slot occasions is {n_{c}, n_{c}+320} due to Nₛₗₒₜ^{frame,3}=160 for SCS=240 kHz. The first device 110 may determine (9260) a repetitions frequency domain resource includes original CORESET0 and extended CORESET0.

The first device 110 may monitor (9070) the Type0-PDCCH repetitions corresponding SFN_{c}/n₀ (PDCCH SFN and Slot) (Step 6-c) and Start Symbols Index/Offset. For example, the 4 times repetition occasion locates the same slot as associated SSB in 2 frames, i.e., SFN #0 and SFN #1, the first 2 occasions are in the first half of SFN #0 and the last 2 occasions in the first half SFN #1. The first device 110 may perform (9080) the reception of Type0-PDCCH and corresponding SIB1. The corresponding repetition occasions may be depicted as shown in FIG. 10C.

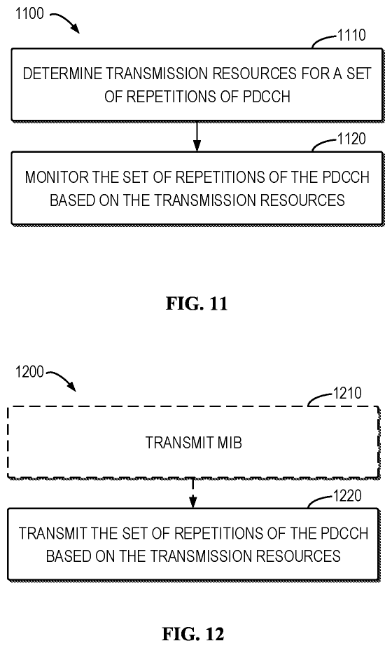

FIG. 11 shows a flowchart of an example method 1100 implemented at a first device in accordance with some example embodiments of the present disclosure. For the purpose of discussion, the method 1100 will be described from the perspective of the first device 110 in FIG. 1.

At block 1110, the apparatus determines transmission resources for a set of repetitions of a physical downlink control channel (PDCCH). In some example embodiments, the set of repetitions is a set of intra-slot repetitions. In some example embodiments, the set of repetitions is a set of repetitions within two consecutive slots.

At block 1120, the apparatus monitors the set of repetitions of the PDCCH from a network device based on the determined transmission resources. In some example embodiments, the method 1100 further comprises: determining the transmission resources for the set of repetition of the PDCCH based on the number of symbols per slot, the number of symbols related to a search space set of the PDCCH, and the number of search space sets per slot.

In some example embodiments, the method 1100 further comprises: determining the transmission resources for the set of repetitions of the PDCCH based on the number of symbols per slot, the number of symbols related to a search space set of the PDCCH, the number of search space sets per slot, and a number of symbols to be reserved for transmission of a scheduled physical downlink shared channel (PDSCH).

In some example embodiments, the method 1100 further comprises determining the transmission resources for the set of repetitions of the PDCCH based on the number of symbols per slot, the number of symbols related to a search space set of the PDCCH, the number of search space sets, the number of symbols to be reserved, and an index of an SSB.

In some example embodiments, the method 1100 further comprises: receiving, from the network device, a master information block indicating at least one parameter related to the set of intra-slot repetitions of the PDCCH.

In some example embodiments, the method 1100 further comprises: determining an intra-slot repetition factor for the PDCCH based on the determined transmission resources.

In some example embodiments, the transmission resources for the set of repetitions of the PDCCH are predefined.

In some example embodiments, the predefined transmission resources are defined in time domain in terms of a starting symbol index within a slot. 10. The apparatus of claim 10, wherein the slot is a same slot of the PDCCH or a next consecutive slot to the slot of the PDCCH or a previous slot to the slot of the PDCCH.

In some example embodiments, the starting symbol index within the slot is 0. In some example embodiments, the starting symbol index within the slot is 2. In some example embodiments, the starting symbol index within the slot is 10. In some example embodiments, the starting symbol index within the slot is 7. In some example embodiments, the starting symbol index within the slot is 12. In some example embodiments, the starting symbol index within the slot is equal to the number of symbols related to a search space set of the PDCCH. In some example embodiments, the starting symbol index within the slot is equal to two times the number of symbols related to a search space set of the PDCCH. In some example embodiments, the starting symbol index within the slot is same as a starting symbol index of the PDCCH.

In some example embodiments, the method 1100 further comprises: determining the transmission resources for the set of repetitions of the PDCCH based on a starting symbol index of the PDCCH within a slot and a time domain offset.

In some example embodiments, the method 1100 further comprises: determining the time domain offset based on the number of symbols related to a search space set of the PDCCH.

In some example embodiments, the transmission resources are defined in frequency domain in terms of a frequency offset from a reference point in frequency domain.

In some example embodiments, the reference point in frequency domain is either a frequency location of a synchronization signal physical broadcast channel block or a frequency location of a control resource set of the PDCCH.

In some example embodiments, the frequency offset is predefined so that the transmission resources are at a lower frequency than a frequency of the reference point.

In some example embodiments, the frequency offset is predefined so that the transmission resources are at a higher frequency than a frequency of the reference point.

In some example embodiments, the frequency offset is predefined in units of resource blocks and is indicated by a reserved value of a control resource set 0 in a parameter pdcch-ConfigSIB1.

In some example embodiments, a size of the transmission resources in frequency domain is the same as that of the PDCCH.

In some example embodiments, a first set of the transmission resources is defined in terms of a first frequency offset from a frequency location of a control resource set of the PDCCH, and a second set of the transmission resources is defined in terms of a second frequency offset from the frequency location of a control resource set of the PDCCH.

In some example embodiments, the first frequency offset is predefined so that the first set of transmission resources are at a lower frequency than the frequency location of the control resource set of the PDCCH, and the second frequency offset is predefined so that the second set of transmission resources are at a higher frequency than the frequency location of the control resource set of the PDCCH.

In some example embodiments, the apparatus is a terminal device.

FIG. 12 shows a flowchart of an example method 1200 implemented at a second device in accordance with some example embodiments of the present disclosure. For the purpose of discussion, the method 1200 will be described from the perspective of the second device 120 in FIG. 1.

In some example embodiments, at block 1210, the second device 120 may transmit a master information block (MIB) to the first device 110. In other words, the first device 110 may receive the MIB from the second device 120.

At block 1220, the apparatus transmits, to a terminal device, a set of repetitions of a physical downlink control channel (PDCCH) based on transmission resources. In some example embodiments, the set of repetitions is a set of intra-slot repetitions. In some example embodiments, the set of repetitions is a set of repetitions within two consecutive slots.

In some example embodiments, the transmission resources for the set of repetition of the PDCCH is determined based on the number of symbols per slot, the number of symbols related to a search space set of the PDCCH, and the number of search space sets per slot.

In some example embodiments, the transmission resources for the set of repetitions of the PDCCH is determined based on the number of symbols per slot, the number of symbols related to a search space set of the PDCCH, the number of search space sets per slot, and a number of symbols to be reserved for transmission of a scheduled physical downlink shared channel (PDSCH).

In some example embodiments, the transmission resources for the set of repetitions of the PDCCH is determined based on the number of symbols per slot, the number of symbols related to a search space set of the PDCCH, the number of search space sets, the number of symbols to be reserved, and an index of an SSB.

In some example embodiments, the method 1200 further comprises: transmitting, to the terminal device, a master information block indicating at least one parameter related to the set of repetitions of the PDCCH.

In some example embodiments, the repetition factor for the PDCCH is determined based on the determined transmission resources.

In some example embodiments, the transmission resources for the set of repetitions of the PDCCH are predefined.

In some example embodiments, the predefined transmission resources are defined in time domain in terms of a starting symbol index within a slot. In some example embodiments, the slot is a same slot of the PDCCH or a next consecutive slot to the slot of the PDCCH or a previous slot to the slot of the PDCCH.

In some example embodiments, the starting symbol index within the slot is 0. In some example embodiments, the starting symbol index within the slot is 2. In some example embodiments, the starting symbol index within the slot is 69. In some example embodiments, the starting symbol index within the slot is 7. In some example embodiments, the starting symbol index within the slot is 12. In some example embodiments, the starting symbol index within the slot is equal to the number of symbols related to a search space set of the PDCCH. In some example embodiments, the starting symbol index within the slot is equal to two times the number of symbols related to a search space set of the PDCCH. In some example embodiments, the starting symbol index within the slot is same as a starting symbol index of the PDCCH.

In some example embodiments, the transmission resources for the set of repetitions of the PDCCH are determined based on a starting symbol index of the PDCCH within a slot and a time domain offset.

In some example embodiments, the time domain offset is determined based on the number of symbols related to a search space set of the PDCCH.

In some example embodiments, the transmission resources are defined in frequency domain in terms of a frequency offset from a reference point in frequency domain.

In some example embodiments, the reference point in frequency domain is either a frequency location of a synchronization signal physical broadcast channel block or a frequency location of a control resource set of the PDCCH.

In some example embodiments, the frequency offset is predefined so that the transmission resources are at a lower frequency than a frequency of the reference point.

In some example embodiments, the frequency offset is predefined so that the transmission resources are at a higher frequency than a frequency of the reference point.

In some example embodiments, the frequency offset is predefined in units of resource blocks and is indicated by a reserved value of a control resource set 0 in a parameter pdcch-ConfigSIB1.

In some example embodiments, a size of the transmission resources in frequency domain is the same as that of the PDCCH.

In some example embodiments, a first set of the transmission resources is defined in terms of a first frequency offset from a frequency location of a control resource set of the PDCCH, and a second set of the transmission resources is defined in terms of a second frequency offset from the frequency location of a control resource set of the PDCCH.

In some example embodiments, the first frequency offset is predefined so that the first set of transmission resources are at a lower frequency than the frequency location of the control resource set of the PDCCH, and the second frequency offset is predefined so that the second set of transmission resources are at a higher frequency than the frequency location of the control resource set of the PDCCH.

In some example embodiments, the apparatus is a network device.

In some example embodiments, a first apparatus capable of performing any of the method 1100 (for example, the first device 110 in FIG. 1) may comprise means for performing the respective operations of the method 1100. The means may be implemented in any suitable form. For example, the means may be implemented in a circuitry or software module. The first apparatus may be implemented as or included in the first device 110 in FIG. 1.

In some example embodiments, the first apparatus comprises means for determining transmission resources for a set of repetitions of a physical downlink control channel (PDCCH); and means for monitoring the set of repetitions of the PDCCH from a network device based on the determined transmission resources.

In some example embodiments, the set of repetitions is a set of intra-slot repetitions.

In some example embodiments, the first apparatus further comprises: means for determining the transmission resources for the set of repetition of the PDCCH based on the number of symbols per slot, the number of symbols related to a search space set of the PDCCH, and the number of search space sets per slot.

In some example embodiments, the first apparatus further comprises: means for determining the transmission resources for the set of repetitions of the PDCCH based on the number of symbols per slot, the number of symbols related to a search space set of the PDCCH, the number of search space sets per slot, and a number of symbols to be reserved for transmission of a scheduled physical downlink shared channel (PDSCH).

In some example embodiments, the apparatus is caused to: means for determining the transmission resources for the set of repetitions of the PDCCH based on the number of symbols per slot, the number of symbols related to a search space set of the PDCCH, the number of search space sets, the number of symbols to be reserved, and an index of an SSB.

In some example embodiments, the set of repetitions is a set of repetitions within two consecutive slots.

In some example embodiments, the first apparatus further comprises: means for receiving, from the network device, a master information block indicating at least one parameter related to the set of repetitions of the PDCCH.

In some example embodiments, the first apparatus further comprises: means for determining an repetition factor for the PDCCH based on the determined transmission resources.

In some example embodiments, the transmission resources for the set of repetitions of the PDCCH are predefined.

In some example embodiments, the predefined transmission resources are defined in time domain in terms of a starting symbol index within a slot. 10. The apparatus of claim 10, wherein the slot is a same slot of the PDCCH or a next consecutive slot to the slot of the PDCCH or a previous slot to the slot of the PDCCH.

In some example embodiments, the starting symbol index within the slot is 0.

In some example embodiments, the starting symbol index within the slot is 2.

In some example embodiments, the starting symbol index within the slot is 10.

In some example embodiments, the starting symbol index within the slot is 7.

In some example embodiments, the starting symbol index within the slot is 12.

In some example embodiments, the starting symbol index within the slot is equal to the number of symbols related to a search space set of the PDCCH.

In some example embodiments, the starting symbol index within the slot is equal to two times the number of symbols related to a search space set of the PDCCH.

In some example embodiments, the starting symbol index within the slot is same as a starting symbol index of the PDCCH.

In some example embodiments, the first apparatus further comprises: means for determining the transmission resources for the set of repetitions of the PDCCH based on a starting symbol index of the PDCCH within a slot and a time domain offset.

In some example embodiments, the first apparatus further comprises: means for determining the time domain offset based on the number of symbols related to a search space set of the PDCCH.

In some example embodiments, the transmission resources are defined in frequency domain in terms of a frequency offset from a reference point in frequency domain.

In some example embodiments, the reference point in frequency domain is either a frequency location of a synchronization signal physical broadcast channel block or a frequency location of a control resource set of the PDCCH.

In some example embodiments, the frequency offset is predefined so that the transmission resources are at a lower frequency than a frequency of the reference point.

In some example embodiments, the frequency offset is predefined so that the transmission resources are at a higher frequency than a frequency of the reference point.

In some example embodiments, the frequency offset is predefined in units of resource blocks and is indicated by a reserved value of a control resource set 0 in a parameter pdcch-ConfigSIB1.

In some example embodiments, a size of the transmission resources in frequency domain is the same as that of the PDCCH.

In some example embodiments, a first set of the transmission resources is defined in terms of a first frequency offset from a frequency location of a control resource set of the PDCCH, and a second set of the transmission resources is defined in terms of a second frequency offset from the frequency location of a control resource set of the PDCCH.

In some example embodiments, the first frequency offset is predefined so that the first set of transmission resources are at a lower frequency than the frequency location of the control resource set of the PDCCH, and the second frequency offset is predefined so that the second set of transmission resources are at a higher frequency than the frequency location of the control resource set of the PDCCH.

In some example embodiments, the apparatus is a terminal device.

In some example embodiments, the first apparatus further comprises means for performing other operations in some example embodiments of the method 1100 or the first device 110. In some example embodiments, the means comprises at least one processor; and at least one memory storing instructions that, when executed by the at least one processor, cause the performance of the first apparatus.

In some example embodiments, a second apparatus capable of performing any of the method 1200 (for example, the second device 120 in FIG. 1) may comprise means for performing the respective operations of the method 1200. The means may be implemented in any suitable form. For example, the means may be implemented in a circuitry or software module. The second apparatus may be implemented as or included in the second device 120 in FIG. 1.

In some example embodiments, the second apparatus comprises means for transmitting, to a terminal device, a set of repetitions of a physical downlink control channel (PDCCH) based on transmission resources.

In some example embodiments, the set of repetitions is a set of intra-slot repetitions.

In some example embodiments, the transmission resources for the set of repetition of the PDCCH is determined based on the number of symbols per slot, the number of symbols related to a search space set of the PDCCH, and the number of search space sets per slot.

In some example embodiments, the transmission resources for the set of repetitions of the PDCCH is determined based on the number of symbols per slot, the number of symbols related to a search space set of the PDCCH, the number of search space sets per slot, and a number of symbols to be reserved for transmission of a scheduled physical downlink shared channel (PDSCH).

In some example embodiments, the transmission resources for the set of repetitions of the PDCCH is determined based on the number of symbols per slot, the number of symbols related to a search space set of the PDCCH, the number of search space sets, the number of symbols to be reserved, and an index of an SSB.

In some example embodiments, the set of repetitions is a set of repetitions within two consecutive slots.

In some example embodiments, the second apparatus further comprises: means for transmitting, to the terminal device, a master information block indicating at least one parameter related to the set of repetitions of the PDCCH.

In some example embodiments, the repetition factor for the PDCCH is determined based on the determined transmission resources.

In some example embodiments, the transmission resources for the set of repetitions of the PDCCH are predefined.

In some example embodiments, the predefined transmission resources are defined in time domain in terms of a starting symbol index within a slot.

In some example embodiments, the slot is a same slot of the PDCCH or a next consecutive slot to the slot of the PDCCH or a previous slot to the slot of the PDCCH.

In some example embodiments, the starting symbol index within the slot is 0.

In some example embodiments, the starting symbol index within the slot is 2.

In some example embodiments, the starting symbol index within the slot is 10.

In some example embodiments, the starting symbol index within the slot is 7.

In some example embodiments, the starting symbol index within the slot is 12.

In some example embodiments, the starting symbol index within the slot is equal to the number of symbols related to a search space set of the PDCCH.

In some example embodiments, the starting symbol index within the slot is equal to two times the number of symbols related to a search space set of the PDCCH.

In some example embodiments, the starting symbol index within the slot is same as a starting symbol index of the PDCCH.

In some example embodiments, the transmission resources for the set of repetitions of the PDCCH are determined based on a starting symbol index of the PDCCH within a slot and a time domain offset.

In some example embodiments, the time domain offset is determined based on the number of symbols related to a search space set of the PDCCH.

In some example embodiments, the transmission resources are defined in frequency domain in terms of a frequency offset from a reference point in frequency domain.

In some example embodiments, the reference point in frequency domain is either a frequency location of a synchronization signal physical broadcast channel block or a frequency location of a control resource set of the PDCCH.

In some example embodiments, the frequency offset is predefined so that the transmission resources are at a lower frequency than a frequency of the reference point.

In some example embodiments, the frequency offset is predefined so that the transmission resources are at a higher frequency than a frequency of the reference point.

In some example embodiments, the frequency offset is predefined in units of resource blocks and is indicated by a reserved value of a control resource set 0 in a parameter pdcch-ConfigSIB1.

In some example embodiments, a size of the transmission resources in frequency domain is the same as that of the PDCCH.

In some example embodiments, a first set of the transmission resources is defined in terms of a first frequency offset from a frequency location of a control resource set of the PDCCH, and a second set of the transmission resources is defined in terms of a second frequency offset from the frequency location of a control resource set of the PDCCH.

In some example embodiments, the first frequency offset is predefined so that the first set of transmission resources are at a lower frequency than the frequency location of the control resource set of the PDCCH, and the second frequency offset is predefined so that the second set of transmission resources are at a higher frequency than the frequency location of the control resource set of the PDCCH.

In some example embodiments, the apparatus is a network device.

In some example embodiments, the second apparatus further comprises means for performing other operations in some example embodiments of the method 1200 or the second device 120. In some example embodiments, the means comprises at least one processor; and at least one memory storing instructions that, when executed by the at least one processor, cause the performance of the second apparatus.

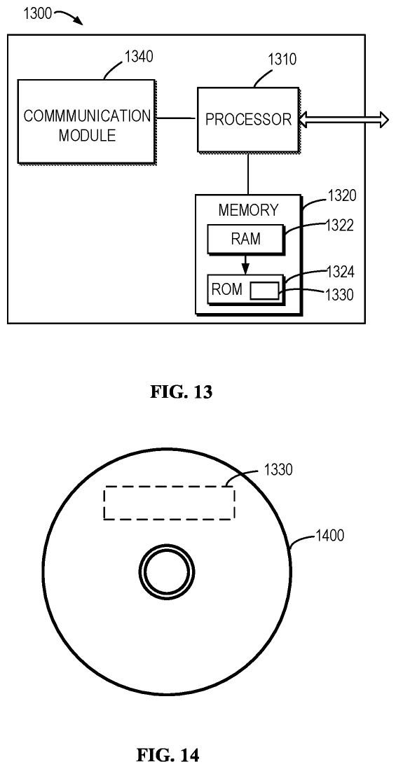

FIG. 13 is a simplified block diagram of a device 1300 that is suitable for implementing example embodiments of the present disclosure. The device 1300 may be provided to implement a communication device, for example, the first device 110 or the second device 120 as shown in FIG. 1. As shown, the device 1300 includes one or more processors 1310, one or more memories 1320 coupled to the processor 1310, and one or more communication modules 1340 coupled to the processor 1310.

The communication module 1340 is for bidirectional communications. The communication module 1340 has one or more communication interfaces to facilitate communication with one or more other modules or devices. The communication interfaces may represent any interface that is necessary for communication with other network elements. In some example embodiments, the communication module 1340 may include at least one antenna.

The processor 1310 may be of any type suitable to the local technical network and may include one or more of the following: general purpose computers, special purpose computers, microprocessors, digital signal processors (DSPs) and processors based on multicore processor architecture, as non-limiting examples. The device 1300 may have multiple processors, such as an application specific integrated circuit chip that is slaved in time to a clock which synchronizes the main processor.

The memory 1320 may include one or more non-volatile memories and one or more volatile memories. Examples of the non-volatile memories include, but are not limited to, a Read Only Memory (ROM) 1324, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 1322 and other volatile memories that will not last in the power-down duration.

A computer program 1330 includes computer executable instructions that are executed by the associated processor 1310. The instructions of the program 1330 may include instructions for performing operations/acts of some example embodiments of the present disclosure. The program 1330 may be stored in the memory, e.g., the ROM 1324. The processor 1310 may perform any suitable actions and processing by loading the program 1330 into the RAM 1322.

The example embodiments of the present disclosure may be implemented by means of the program 1330 so that the device 1300 may perform any process of the disclosure as discussed with reference to FIG. 2 to FIG. 12. The example embodiments of the present disclosure may also be implemented by hardware or by a combination of software and hardware.

In some example embodiments, the program 1330 may be tangibly contained in a computer readable medium which may be included in the device 1300 (such as in the memory 1320) or other storage devices that are accessible by the device 1300. The device 1300 may load the program 1330 from the computer readable medium to the RAM 1322 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 14 shows an example of the computer readable medium 1400 which may be in form of CD, DVD or other optical storage disk. The computer readable medium 1400 has the program 1330 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-63. (canceled)

64. An apparatus comprising:
at least one processor; and
at least one memory storing instructions that, when executed by the at least one processor, cause the apparatus to:
determine transmission resources for a set of repetitions of a physical downlink control channel (PDCCH) based on a number of symbols per slot, the number of symbols related to a search space set of the PDCCH, the number of search space sets per slot, and a number of symbols to be reserved for transmission of a scheduled physical downlink shared channel (PDSCH), wherein the set of repetitions is a set of repetitions within two consecutive slots, and wherein the transmission resources are defined in frequency domain in terms of a frequency offset from a reference point in frequency domain, wherein the reference point in frequency domain is a frequency location of a synchronization signal physical broadcast channel block, and wherein the starting symbol index within the slot is equal to two times the number of symbols related to a search space set of the PDCCH, wherein the frequency offset is predefined so that the transmission resources are at a lower frequency than a frequency of the reference point, and wherein a size of the transmission resources in frequency domain is a same as that of the PDCCH; and
monitor the set of repetitions of the PDCCH from a network device based on the determined transmission resources.

65. The apparatus of claim 64, wherein the apparatus is caused to:
receive, from the network device, a master information block indicating at least one parameter related to the set of repetitions of the PDCCH.

66. The apparatus of claim 65, wherein the apparatus is caused to:
determine an intra-slot repetition factor for the PDCCH based on the determined transmission resources.

67. The apparatus of claim 66, wherein a first set of the transmission resources is defined in terms of a first frequency offset from a frequency location of a control resource set of the PDCCH.

68. The apparatus of claim 67, wherein a second set of the transmission resources is defined in terms of a second frequency offset from the frequency location of a control resource set of the PDCCH.

69. The apparatus of claim 68, wherein the first frequency offset is predefined so that the first set of transmission resources are at a lower frequency than the frequency location of the control resource set of the PDCCH.

70. The apparatus of claim 69, wherein the second frequency offset is predefined so that the second set of transmission resources are at a higher frequency than the frequency location of the control resource set of the PDCCH.

71. The apparatus of claim 70, wherein the apparatus is a terminal device.

72. A system comprising:
an apparatus:
at least one processor; and
at least one memory storing instructions that, when executed by the at least one processor, cause the apparatus to:
determine transmission resources for a set of repetitions of a physical downlink control channel (PDCCH) based on a number of symbols per slot, the number of symbols related to a search space set of the PDCCH, the number of search space sets per slot, and a number of symbols to be reserved for transmission of a scheduled physical downlink shared channel (PDSCH), wherein the set of repetitions is a set of repetitions within two consecutive slots, and wherein the transmission resources are defined in frequency domain in terms of a frequency offset from a reference point in frequency domain, wherein the reference point in frequency domain is a frequency location of a synchronization signal physical broadcast channel block, and wherein the starting symbol index within the slot is equal to two times the number of symbols related to a search space set of the PDCCH, wherein the frequency offset is predefined so that the transmission resources are at a lower frequency than a frequency of the reference point, and wherein a size of the transmission resources in frequency domain is a same as that of the PDCCH; and
monitor the set of repetitions of the PDCCH from a network device based on the determined transmission resources.

73. The system of claim 72, wherein the apparatus is caused to:
receive, from the network device, a master information block indicating at least one parameter related to the set of repetitions of the PDCCH.

74. The system of claim 73, wherein the apparatus is caused to:
determine an intra-slot repetition factor for the PDCCH based on the determined transmission resources.

75. The system of claim 74, wherein a first set of the transmission resources is defined in terms of a first frequency offset from a frequency location of a control resource set of the PDCCH.

76. The system of claim 75, wherein a second set of the transmission resources is defined in terms of a second frequency offset from the frequency location of a control resource set of the PDCCH.

77. The system of claim 76, wherein the first frequency offset is predefined so that the first set of transmission resources are at a lower frequency than the frequency location of the control resource set of the PDCCH.

78. The system of claim 77, wherein the second frequency offset is predefined so that the second set of transmission resources are at a higher frequency than the frequency location of the control resource set of the PDCCH.

79. The system of claim 78, wherein the apparatus is a terminal device.

80. A method comprising:
determining transmission resources for a set of repetitions of a physical downlink control channel (PDCCH) based on the following: a number of symbols per slot, the number of symbols related to a search space set of the PDCCH, the number of search space sets per slot, and a number of symbols to be reserved for transmission of a scheduled physical downlink shared channel (PDSCH), wherein the set of repetitions is a set of repetitions within two consecutive slots, and wherein the transmission resources are defined in frequency domain in terms of a frequency offset from a reference point in frequency domain, wherein the reference point in frequency domain is a frequency location of a synchronization signal physical broadcast channel block, and wherein the starting symbol index within the slot is equal to two times the number of symbols related to a search space set of the PDCCH, wherein the frequency offset is predefined so that the transmission resources are at a lower frequency than a frequency of the reference point, and wherein a size of the transmission resources in frequency domain is a same as that of the PDCCH; and
monitoring the set of repetitions of the PDCCH from a network device based on the determined transmission resources.

81. The method of claim 80, further comprising:
receiving, from the network device, a master information block indicating at least one parameter related to the set of repetitions of the PDCCH.

82. The method of claim 81, further comprising:
determining an intra-slot repetition factor for the PDCCH based on the determined transmission resources.

83. The method of claim 82, wherein a first set of the transmission resources is defined in terms of a first frequency offset from a frequency location of a control resource set of the PDCCH, wherein a second set of the transmission resources is defined in terms of a second frequency offset from the frequency location of a control resource set of the PDCCH, and wherein the first frequency offset is predefined so that the first set of transmission resources are at a lower frequency than the frequency location of the control resource set of the PDCCH.
